(19) United States
(12) Patent Application Publication
(10) Pub. No.: US 2020/0089139 A1
(43) Pub. Date: Mar. 19, 2020

(54) TONER FOR DEVELOPING ELECTROSTATIC IMAGES

(71) Applicant: KAO CORPORATION, Tokyo (JP)

(72) Inventors: Norihiro HIRAI, Wakayama-shi (JP); Tomohide YOSHIDA, Wakayama-shi (JP); Takashi KANNO, Wakayama-shi (JP)

(73) Assignee: KAO CORPORATION, Tokyo (JP)

(21) Appl. No.: 16/616,314

(22) PCT Filed: Mar. 22, 2018
(86) PCT No.: PCT/JP2018/011523

§ 371 Date: Nov. 22, 2019

(30) Foreign Application Priority Data
May 24, 2017 (JP) 2017-102631
Jun. 30, 2017 (JP) 2017-129259
Oct. 10, 2017 (JP) 2017-197136-
Oct. 10, 2017 (JP) 2017-197137

(51) Int. Cl. G03G 9/087

(52) U.S. Cl. CPC G03G 9/08755; G03G 9/08797; G03G 9/08733

(57) ABSTRACT

Provided are a toner for developing electrostatic images excellent in low-temperature fusing property, gloss and carrier contamination resistance, and a wax dispersant. [1] A toner for developing electrostatic images, containing an amorphous composite resin (A), an amorphous polyester resin (B), and a wax, wherein the amorphous composite resin (A) contains a polyester resin segment which is a polycondensate of an alcohol component containing an aromatic diol and a carboxylic acid component containing an aliphatic dicarboxylic acid whose main chain has 8 or more and 14 or less carbon atoms, a vinylic resin segment of an addition polymer of a raw material monomer containing a styrenic compound, and a constitutional unit derived from a bireactive monomer, the constitutional unit bonding to the polyester resin segment and the vinylic resin segment each via a covalent bond; and has a glass transition temperature not lower than 45° C., and the ratio by mass of the amorphous composite resin (A) to the amorphous polyester resin (B) [(A)/(B)] is 1/99 or more and 60/40 or less; and [2] a wax dispersant containing the amorphous composite resin (A).

### FIELD OF THE INVENTION

The present invention relates to a toner for developing electrostatic images, which is used for developing latent images formed according to an electrophotographic method, an electrostatic recording method, an electrostatic printing method, etc., and to a wax dispersant, etc.

### BACKGROUND OF THE INVENTION

In the field of electrophotography, it is desired to develop a toner for electrophotography that can enhance picture quality and satisfy speed-up technique with the development of electrophotographic systems.

Patent Literature 1 describes a method for producing a toner for electrostatic images that includes a step (1) for obtaining agglomerated particles (1) by agglomerating resin particles (X) containing a composite resin that contains a segment of a polyester resin (a) obtained through polycondensation of an alcohol component containing an ethylene oxide adduct of bisphenol A in an amount of 80 mol % or more and a polycarboxylic acid component in an aqueous medium, and a vinylic resin segment containing a styrenic compound-derived constitutional unit, a step (2) for obtaining agglomerated particles (2) by performing agglomeration of resin particles (Y) containing a polyester resin (b) obtained through polycondensation of an alcohol component containing a propylene oxide adduct of bisphenol A in an amount of 80 mol % or more and a polycarboxylic acid component on the agglomerated particles (1) obtained in the step (1), and a step (3) for fusing the agglomerated particles (2) obtained in the step (2). The literature says that, according to the production method, a toner excellent in low-temperature fusing property and heat-resistant storability can be obtained.

Patent Literature 2 describes a toner for developing electrostatic images having a core/shell structure, wherein the core moiety contains a binder resin containing a composite resin (A) and a crystalline polyester (B); and a wax, the shell moiety contains a binder resin containing a polyester resin (C), the composite resin (A) is a composite resin containing a segment (a1) of a polyester resin obtained through polycondensation of an alcohol component containing a propylene oxide adduct of bisphenol A in an amount of 80 mol % or more and a polycarboxylic acid component, and a vinylic resin segment (a2) containing a styrenic compound-derived constitutional unit, the crystalline polyester (B) is a crystalline polyester obtained through polycondensation of an alcohol component containing an α,ω-aliphatic diol having 8 or more and 16 or less carbon atoms in an amount of 80 mol % or more and a polycarboxylic acid component containing an aliphatic saturated dicarboxylic acid having 8 or more and 16 or less carbon atoms in an amount of 80 mol % or more, and the polyester resin (C) is a polyester resin obtained through polycondensation of an alcohol component containing an ethylene oxide adduct of bisphenol A in an amount of 80 mol % or more and a polycarboxylic acid component. The literature says that the toner satisfies both excellent low-temperature fusing property and heat-resistant storability and is excellent in electrostatic property.

Patent Literature 3 describes a method for producing an aqueous dispersion of a binder resin composition particles for electrophotographic toner that contains an amorphous composite resin (A) and a crystalline polyester resin (C), wherein the amorphous composite resin (A) is a resin containing a polycondensate-type resin component (A-1) obtained through polycondensation of an alcohol component and a carboxylic acid component containing an aliphatic dicarboxylic acid compound having 8 or more and 14 or less carbon atoms, and a styrenic resin component (A-2), and the crystalline polyester (C) is a resin obtained through polycondensation of an alcohol component containing an aliphatic diol having 8 or more and 14 or less carbon atoms in an amount of 80 mol % or more and 100 mol % or less, and a carboxylic acid component containing an aliphatic dicarboxylic acid having 8 or more and 14 or less carbon atoms in an amount of 80 mol % or more and 100 mol % or less; the method including a step 1 of mixing the amorphous composite resin (A) and the crystalline polyester resin (C) to give a mixture, a step 2 of mixing a neutralizing agent in the mixture obtained in the step 1, and a step 3 of performing phase-transfer emulsification by adding an aqueous medium to the mixture obtained in the step 2. The literature says that, according to the production method, an aqueous dispersion of binder resin composition particles for electrophotographic toners can be obtained, which can give an electrophotographic toner excellent in low-temperature fusing property, heat-resistant storability under high humidity, and durability.

### CITATION LIST

### Patent Literature

Patent Literature 1: JP 2016-014872A

Patent Literature 2: JP 2016-114934A

Patent Literature 3: JP 2016-133769A

### SUMMARY OF THE INVENTION

The present invention relates to the following aspects [1] and [2].

[1] A toner for developing electrostatic images, containing an amorphous composite resin (A), an amorphous polyester resin (B), and a wax, wherein:

the amorphous composite resin (A) contains a polyester resin segment which is a polycondensate of an alcohol component containing an aromatic diol and a carboxylic acid component containing an aliphatic dicarboxylic acid whose main chain has 8 or more and 14 or less carbon atoms, a vinylic resin segment of an addition polymer of a raw material monomer containing a styrenic compound, and a constitutional unit derived from a bireactive monomer, the constitutional unit bonding to the polyester resin segment and the vinylic resin segment each via a covalent bond; and has a glass transition temperature not lower than 45° C., and

the ratio by mass of the amorphous composite resin (A) to the amorphous polyester resin (B) [(A)/(B)] is 1/99 or more and 60/40 or less.

[2] A wax dispersant containing an amorphous composite resin (A), which contains a polyester resin segment which is a polycondensate of an alcohol component containing an aromatic diol and a carboxylic acid component containing an aliphatic dicarboxylic acid whose main chain has 8 or more and 14 or less carbon atoms, a vinylic resin segment of an addition polymer of a raw material monomer containing a styrenic compound, and a constitutional unit derived from a bireactive monomer, the constitutional unit bonding to the polyester resin segment and the vinylic resin segment each via a covalent bond, and has a glass transition temperature not lower than 45° C.

### DETAILED DESCRIPTION OF THE INVENTION

The technologies of Patent Literatures 1 to 3 still have problems in point of gloss of prints, and contamination with the carrier to be used along with the toner particles. In other words, the technologies of Patent Literatures 1 to 3 are still desired to be improved in point of low-temperature fusing property, gloss and carrier contamination resistance.

The present invention relates to a toner for developing electrostatic images excellent in low-temperature fusing property, gloss and carrier contamination resistance, and to a wax dispersant. In other words, the present invention relates to the above-mentioned aspects [1] and [2].

According to the present invention, there can be provided a toner for developing electrostatic images excellent in low-temperature fusing property, gloss and carrier contamination resistance, and a wax dispersant.

### [Toner for Developing Electrostatic Images]

The toner for developing electrostatic images of the present invention (hereinafter this may be simply referred to as “toner”) contains an amorphous composite resin (A) (hereinafter this may be simply referred to as “composite resin (A)”), an amorphous polyester resin (B) (hereinafter this may be simply referred to as “polyester resin (B)”), and a wax.

The composite resin (A) contains a polyester resin segment which is a polycondensate of an alcohol component containing an aromatic diol and a carboxylic acid component containing an aliphatic dicarboxylic acid whose main chain has 8 or more and 14 or less carbon atoms, a vinylic resin segment of an addition polymer of a raw material monomer containing a styrenic compound, and a constitutional unit derived from a bireactive monomer, the constitutional unit bonding to the polyester resin segment and the vinylic resin segment each via a covalent bond; and has a glass transition temperature not lower than 45° C.

Further, the ratio by mass of the composite resin (A) to the polyester resin (B) [(A)/(B)] is 1/99 or more and 60/40 or less.

Having the constitution as above, there can be obtained a toner for developing electrostatic images excellent in low-temperature fusing property, gloss and carrier contamination resistance. Though not clear, the reason can be considered to be as follows.

The toner of the present invention contains the composite resin (A) which contains a vinylic resin segment of an addition polymer of a raw material monomer containing a styrenic compound and which has high hydrophobicity. Consequently, wax dispersibility therein improves to prevent carrier contamination with a wax domain vulnerable to heat and friction (external force). Further, an aliphatic dicarboxylic acid is introduced into the main chain of the composite resin (A), and therefore the strength of the resin itself is also high to prevent carrier contamination. Moreover, the glass transition temperature of the composite resin (A) is not lower than 45° C. and is high, and therefore a low-glass transition temperature component in the toner can be significantly reduced to prevent carrier contamination.

In addition, the composite resin (A) contains a hydrophobic moiety and a hydrophilic moiety, and therefore it has been found that the toner materials including wax can be dispersed more uniformly than before in the toner particles to reduce the toner surface unevenness after fusing and increase the gloss of prints.

The definitions of various terms in this description are described below.

Whether a resin is crystalline or amorphous can be determined by the crystallinity index of the resin. The crystallinity index is defined by a ratio of the softening point of a resin to the endothermic maximum peak temperature thereof (softening point (° C.)/endothermic maximum peak temperature (° C.) in the measurement method described in the section of Examples given hereinunder. A crystalline resin is a resin whose crystallinity index is 0.6 or more and less than 1.4, preferably 0.7 or more, more preferably 0.9 or more, and is preferably 1.2 or less. An amorphous resin is a resin whose crystallinity index is 1.4 or more or less than 0.6, preferably 1.5 or more or 0.5 or less, and more preferably 1.6 or more or 0.5 or less. The crystallinity index can be appropriately controlled depending on the kind and the ratio of raw material monomers, as well as on the production conditions such as the reaction temperature, the reaction time and the cooling speed. The endothermic maximum peak temperature indicates a temperature of the peak on the highest temperature side among the observed endothermic peaks. The crystallinity index can be calculated from the values obtained according to the measurement methods for a softening point and an endothermic maximum peak temperature of a resin described in the section of Examples.

In this description, the carboxylic acid component of the polyester resin includes not only the exemplified compounds thereof but also anhydrides and alkyl esters of each carboxylic acid (where the alkyl group has 1 or more and 3 or less carbon atoms) that can produce an acid through decomposition during reaction.

In the description, “binder resin” means a resin component contained in the toner that contains the composite resin (A) and the polyester resin (B).

### <Amorphous Composite Resin (A)>

The composite resin (A) contains a polyester resin segment which is a polycondensate of an alcohol component containing an aromatic diol and a carboxylic acid component containing an aliphatic dicarboxylic acid whose main chain has 8 or more and 14 or less carbon atoms, a vinylic resin segment of an addition polymer of a raw material monomer containing a styrenic compound, and a constitutional unit derived from a bireactive monomer, the constitutional unit bonding to the polyester resin segment and the vinylic resin segment each via a covalent bond, from the viewpoint of providing a toner excellent in low-temperature fusing property, gloss and carrier contamination resistance.

### [Polyester Resin Segment]

The polyester resin segment is a polycondensate of an alcohol component containing an aromatic diol and a carboxylic acid component containing an aliphatic dicarboxylic acid whose main chain has 8 or more and 14 or less carbon atoms, from the viewpoint of providing a toner excellent in low-temperature fusing property, gloss and carrier contamination resistance.

The aromatic diol is preferably an alkylene oxide adduct of bisphenol A, and is more preferably an alkylene oxide adduct of bisphenol A represented by a formula (I):

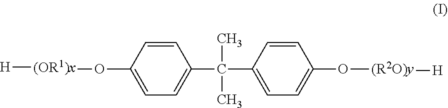

wherein R¹O and OR² each represent an oxyalkylene group, R¹ and R² each independently represent an ethylene or propylene group, x and y each represent an average addition molar number of an alkylene oxide and each are a positive number, a value of the sum of x and y is 1 or more, preferably 1.5 or more, and is 16 or less, preferably 8 or less, more preferably 4 or less.

Examples of the alkylene oxide adduct of bisphenol A include a [2,2-bis(4-hydroxyphenyl)propane] polyoxypropylene adduct of bisphenol A, and a polyoxyethylene adduct of bisphenol A. Preferably, one or more of these are used.

The amount of the alkylene oxide adduct of bisphenol A is preferably 70 mol % or more in the alcohol component, more preferably 90 mol % or more, even more preferably 95 mol % or more, and is preferably 100 mol % or less, and further more preferably 100 mol %.

In addition to the aromatic diol, the alcohol component may contain a linear or branched aliphatic diol, an alicyclic diol and a trihydric or higher polyalcohol.

Examples of the linear or branched aliphatic diol include ethylene glycol, 1,2-propanediol, 1,3-propanediol, 1,2-butanediol, 1,3-butanediol, 1,4-butanediol, 2,3-butanediol, 2,2-dimethyl-1,3-butanediol, 1,6-hexanediol, 1,8-octanediol, 1,9-nonanediol, 1,10-decanediol and 1,12-dodecanediol.

Examples of the alicyclic diol include hydrogenated bisphenol A [2,2-bis(4-hydroxycyclohexyl)propane], and adducts of hydrogenated bisphenol A with an alkylene oxide having 2 or more and 4 or less carbon atoms (with an average addition molar number of 2 or more and 12 or less).

Examples of the trihydric or higher polyalcohol include glycerin, pentaerythritol, trimethylolpropane and sorbitol.

One alone or two or more of these alcohol components may be used either singly or as combined.

Since the carboxylic acid component contains an aliphatic dicarboxylic acid whose main chain has 8 or more and 14 or less carbon atoms, a toner excellent in gloss and carrier contamination resistance can be obtained.

The aliphatic dicarboxylic acid is preferably a linear aliphatic dicarboxylic acid.

The carbon number of the main chain of the aliphatic dicarboxylic acid is preferably 10 or more and 14 or less.

Examples of the aliphatic dicarboxylic acid whose main chain has 8 or more and 14 or less carbon atoms include sebacic acid, dodecanedioic acid, and tetradecanedioic acid. Among these, from the viewpoint of more improving carrier contamination resistance, sebacic acid and dodecanedioic acid are preferred. From the viewpoint of more improving low-temperature fusing property, tetradecanedioic acid is preferred.

The amount of the aliphatic dicarboxylic acid whose main chain has 8 or more and 14 or less carbon atoms is, from the viewpoint of more improving toner low-temperature fusing property, gloss and carrier contamination resistance, preferably 2 mol % or more in the carboxylic acid component, more preferably 3 mol % or more, even more preferably 10 mol % or more, further more preferably 15 mol % or more, and is preferably 40 mol % or less, more preferably 35 mol % or less, even more preferably 30 mol % or less, and is, from the viewpoint of more improving toner gloss and carrier contamination resistance, even more preferably 25 mol % or less.

Examples of the other carboxylic acid component than the aliphatic dicarboxylic acid whose main chain has 8 or more and 14 or less carbon atoms include other dicarboxylic acids and tribasic or higher polycarboxylic acids.

Examples of the other dicarboxylic acids include an aromatic dicarboxylic acid, a linear or branched aliphatic dicarboxylic acid having 9 or less carbon atoms, a linear or branched aliphatic dicarboxylic acid having 15 or more carbon atoms, and an alicyclic dicarboxylic acid. Among these, an aromatic dicarboxylic acid is preferred.

Examples of the aromatic dicarboxylic acid include phthalic acid, isophthalic acid and terephthalic acid. Among these, isophthalic acid and terephthalic acid are preferred, and terephthalic acid is more preferred.

The amount of the aromatic dicarboxylic acid is preferably 30 mol % or more in the carboxylic acid component, more preferably 40 mol % or more, even more preferably 50 mol % or more, and is preferably 90 mol % or less, more preferably 80 mol % or less, even more preferably 75 mol % or less.

Examples of the linear or branched aliphatic dicarboxylic acid having 7 or less carbon atoms, and the linear or branched aliphatic dicarboxylic acid having 15 or more carbon atoms include oxalic acid, malonic acid, maleic acid, fumaric acid, citraconic acid, itaconic acid, glutaconic acid, succinic acid, adipic acid, and succinic acid substituted with an alkyl group having 1 or more and 20 or less carbon atoms or an alkenyl group having 2 or more and 20 or less carbon atoms. Examples of the succinic acid substituted with an alkyl group having 1 or more and 20 or less carbon atoms or an alkenyl group having 2 or more and 20 or less carbon atoms include dodecylsuccinic acid, dodecenylsuccinic acid and octenylsuccinic acid.

The tribasic or higher polycarboxylic acid is preferably a tribasic carboxylic acid, and examples thereof include trimellitic acid. Among these, trimellitic acid or an anhydride thereof is preferred.

In the case where the carboxylic acid component contains a tribasic or higher polycarboxylic acid, the amount of the tribasic or higher polycarboxylic acid is preferably 1 mol % or more in the carboxylic acid component, more preferably 2 mol % or more, and is preferably 30 mol % or less, more preferably 20 mol % or less, even more preferably 10 mol % or less, and further more preferably 5 mol % or less.

One alone or two or more of these carboxylic acid components may be used either singly or as combined.

The ratio of the carboxy group in the carboxylic acid component to the hydroxy group in the alcohol component (COOH group/OH group) is preferably 0.7 or more, more preferably 0.8 or more, and is preferably 1.3 or less, more preferably 1.2 or less.

### [Vinylic Resin Segment]

The vinylic resin segment is, from the viewpoint of providing a toner excellent in low-temperature fusing property, gloss and carrier contamination resistance, an addition polymer of a raw material monomer containing a styrenic compound, and is preferably an addition polymer of a raw material monomer containing a styrenic compound and a vinylic monomer having an aliphatic hydrocarbon group having 3 or more and 22 or less carbon atoms.

Examples of the styrenic compound include a substituted or unsubstituted styrene. Examples of the substituent include an alkyl group having 1 or more and 5 or less carbon atoms, a halogen atom, an alkoxy group having 1 or more and 5 or less carbon atoms, a sulfonic acid group or a salt thereof.

Examples of the styrenic compound include styrene compounds such as styrene, methylstyrene, α-methylstyrene, β-methylstyrene, tert-butylstyrene, chlorostyrene, chloromethylstyrene, methoxystyrene, styrenesulfonic acid or a salt thereof. Among these, styrene is preferred.

The amount of the styrenic compound is, from the viewpoint of more improving toner low-temperature fusing property, gloss and carrier contamination resistance, preferably 50% by mass or more in the raw material monomer for the vinylic resin segment, more preferably 65% by mass or more, even more preferably 70% by mass or more, and is preferably 95% by mass or less, more preferably 90% by mass or less, even more preferably 85% by mass or less.

In the vinylic monomer having an aliphatic hydrocarbon group, the carbon number of the hydrocarbon group is, from the viewpoint of more improving toner low-temperature fusing property, gloss and carrier contamination resistance, preferably 3 or more, more preferably 4 or more, even more preferably 6 or more, and is preferably 22 or less, more preferably 20 or less, even more preferably 18 or less.

Examples of the aliphatic hydrocarbon group include an alkyl group, an alkynyl group, and an alkenyl group. Among these, an alkyl group and an alkenyl group are preferred, and an alkyl group is more preferred. The aliphatic hydrocarbon group may be branched or linear.

The vinylic monomer having an aliphatic hydrocarbon group is preferably an alkyl ester of (meth)acrylic acid. In the case of an alkyl ester of (meth)acrylic acid, the hydrocarbon group is an alcohol moiety residue of the ester.

Examples of the alkyl ester of (meth)acrylic acid include (iso)propyl (meth)acrylate, (iso)butyl (meth)acrylate, (iso)hexyl (meth)acrylate, cyclohexyl (meth)acrylate, (iso)octyl (meth)acrylate (hereinafter this may be referred to as 2-ethylhexyl (meth)acrylate), (iso)decyl (meth)acrylate, (iso)dodecyl (meth)acrylate (hereinafter this may be referred to as (iso)lauryl (meth)acrylate), (iso)palmityl (meth)acrylate, (iso)stearyl (meth)acrylate, and (iso)behenyl (meth)acrylate. Among these, 2-ethylhexyl (meth)acrylate is preferred.

Here, “alkyl (meth)acrylate” indicates an alkyl acrylate or an alkyl methacrylate. “(Iso)” of an alkyl moiety means a normal alkyl or an isoalkyl.

The amount of the vinylic monomer having an aliphatic hydrocarbon group having 3 or more and 22 or less carbon atoms is, from the viewpoint of more improving toner gloss and carrier contamination resistance, preferably 5% by mass or more in the raw material monomer for the vinylic resin segment, more preferably 10% by mass or more, even more preferably 15% by mass or more, and is preferably 50% by mass or less, more preferably 35% by mass or less, even more preferably 25% by mass or less.

Examples of the other raw material monomer include ethylenic unsaturated monoolefins such as ethylene and propylene; conjugated dienes such as butadiene; vinyl halides such as vinyl chloride; vinyl esters such as vinyl propionate; aminoalkyl (meth)acrylates such as dimethylaminoethyl (meth)acrylate; vinyl ethers such as methyl vinyl ether; vinylidene halides such as vinylidene chloride; and N-vinyl compounds such as N-vinylpyrrolidone.

The total amount of the styrenic compound and the vinylic monomer having an aliphatic hydrocarbon group having 3 or more and 22 or less carbon atoms in the raw material monomer for the vinylic resin segment is, from the viewpoint of more improving toner low-temperature fusing property, gloss and carrier contamination resistance, preferably 80% by mass or more, more preferably 90% by mass or more, even more preferably 95% by mass or ore, and is 100% by mass or less, preferably 100% by mass.

[Constitutional Unit Derived from Bireactive Monomer]

The composite resin (A) has a constitutional unit derived from a bireactive monomer that bonds to the polyester resin segment and the vinylic resin segment each via a covalent bond, for the purpose of connecting the polyester resin segment and the vinylic resin segment.

“Constitutional unit derived from a bireactive monomer” means a unit formed through reaction of a functional group of a bireactive monomer and a vinyl moiety.

Examples of the bireactive monomer include a vinylic monomer having at least one functional group selected from a hydroxy group, a carboxy group, an epoxy group, a primary amino group and a secondary amino group, in the molecule. Among these, a vinylic monomer having a hydroxy group or a carboxy group is preferred from the viewpoint of reactivity, a vinylic monomer having a carboxy group is more preferred.

Examples of the bireactive monomer include acrylic acid, methacrylic acid, fumaric acid and maleic acid. Among these, from the viewpoint of reactivity for both polycondensation and addition polymerization, acrylic acid and methacrylic acid are preferred, and acrylic acid is more preferred.

The amount of the bireactive monomer-derived constitutional unit is preferably 1 part by mol or more relative to 100 parts by mol of the alcohol component for the polyester resin segment of the composite resin (A), more preferably 5 parts by mol or more, even more preferably 8 parts by mol or more, and is preferably 30 parts by mol or less, more preferably 25 parts by mol or less, even more preferably 20 parts by mol or less.

The amount of the polyester resin segment is, from the viewpoint of more improving toner low-temperature fusing property, gloss and carrier contamination resistance, preferably 40% by mass or more in the composite resin (A), more preferably 50% by mass or more, even more preferably 55% by mass or more, and is preferably 95% by mass or less, more preferably 85% by mass or less, even more preferably 80% by mass or less, and further more preferably 70% by mass or less.

The amount of the vinylic resin segment is, from the viewpoint of more improving toner low-temperature fusing property, gloss and carrier contamination resistance, preferably 10% by mass or more in the composite resin (A), more preferably 15% by mass or more, even more preferably 20% by mass or more, still more preferably 25% by mass or more, further more preferably 35% by mass or more, and is preferably 60% by mass or less, more preferably 50% by mass or less, even more preferably 45% by mass or less, still more preferably 40% by mass or less.

The amount of the bireactive monomer-derived constitutional unit is, from the viewpoint of more improving toner low-temperature fusing property, gloss and carrier contamination resistance, preferably 0.1% by mass or more in the composite resin (A), more preferably 0.5% by mass or more, even more preferably 0.8% by mass or more, and is preferably 10% by mass or less, more preferably 5% by mass or less, even more preferably 3% by mass or less.

The total amount of the polyester resin segment, the vinylic resin segment and the bireactive monomer-derived constitutional unit in the composite resin (A) is, from the viewpoint of more improving toner low-temperature fusing property, gloss and carrier contamination resistance, preferably 80% by mass or more, more preferably 90% by mass or more, even more preferably 93% by mass or more, still more preferably 95% by mass or more, and is preferably 100% by mass or less, more preferably 99% by mass or less.

The above-mentioned amount is calculated on the basis of the proportion of the amount of the raw material monomers for the polyester resin segment and the vinylic resin segment, the amount of the bireactive monomer and the amount of a polymerization initiator if used, for which water removal in polycondensation for the polyester resin segment is disregarded. In the case where a polymerization initiator is used, the mass of the polymerization initiator is included in the vinylic resin segment for the calculation.

### [Physical Properties of Amorphous Composite Resin (A)]

The acid value of the composite resin (A) is preferably 5 mgKOH/g or more, more preferably 8 mgKOH/g or more, even more preferably 10 mgKOH/g or more, and is preferably 40 mgKOH/g or less, more preferably 35 mgKOH/g or less, even more preferably 30 mgKOH/g or less, still more preferably 23 mgKOH/g or less, and from the viewpoint of gloss and carrier contamination resistance, the acid value is further more preferably 17 mgKOH/g or less.

The hydroxyl value of the composite resin (A) is preferably 5 mgKOH/g or more, more preferably 15 mgKOH/g or more, even more preferably 20 mgKOH/g or more, still more preferably 25 mgKOH/g or more, and is preferably 60 mgKOH/g or less, more preferably 50 mgKOH/g or less, even more preferably 40 mgKOH/g or less.

The softening point of the composite resin (A) is, from the viewpoint of more improving low-temperature fusing property, preferably 70° C. or higher, more preferably 90° C. or higher, even more preferably 100° C. or higher, still more preferably 110° C. or higher, and is preferably 140° C. or lower, more preferably 130° C. or lower, even more preferably 125° C. or lower.

The glass transition temperature of the composite resin (A) is, from the viewpoint of providing a toner excellent in low-temperature fusing property, gloss and carrier contamination resistance, 45° C. or higher, and is, from the viewpoint of more improving gloss and carrier contamination resistance, preferably 48° C. or higher, more preferably 50° C. or higher, even more preferably 52° C. or higher, and is preferably 70° C. or lower, more preferably 60° C. or lower, even more preferably 55° C. or lower.

The acid value, the hydroxyl value, the softening point and the glass transition temperature of the composite resin (A) can be appropriately controlled depending on the kind and the amount of the raw material monomers, and on the production conditions such as the reaction temperature, the reaction time and the cooling rate, and the values can be determined according to the methods described in the section of Examples.

In the case where two or more kinds of composite resins (A) are used as combined, preferably, the acid value, the hydroxyl value, the softening point and the glass transition temperature of any of them can fall within the above-mentioned range.

### [Production Method for Composite Resin (A)]

A production method for the composite resin (A) includes, for example, polycondensation of an alcohol component and a carboxylic acid component and addition polymerization of a raw material monomer for a vinylic resin segment and a bireactive monomer, and examples thereof include the following methods (i) to (iii).

(i) A method of polycondensation of an alcohol component and a carboxylic acid component followed by addition polymerization of a reactive monomer for an addition polymer resin segment and a bireactive monomer.

(ii) A method of addition polymerization of a raw material monomer for a vinylic resin segment and a bireactive monomer followed by polycondensation of a raw material monomer for a polyester resin segment.

(iii) A method of simultaneous polycondensation of an alcohol component and a carboxylic acid component and addition polymerization of a raw material monomer for an addition polymer resin segment and a bireactive monomer.

Preferably, the polycondensation and the addition polymerization in the above-mentioned methods (i) to (iii) are carried out in one and the same chamber.

Preferably, the composite resin is produced according to the method (i) or (ii) from the viewpoint of high freedom in the reaction temperature for polycondensation reaction, and the method (i) is more preferred.

From the viewpoint of reactivity, catalysts such as an esterification catalyst and an esterification promoter can be used, and further, a polymerization initiator and a polymerization inhibitor can also be used.

In polycondensation, if desired, an esterification catalyst such as tin(II) 2-ethylhexanoate, dibutyltin oxide or titanium diisopropylate bistriethanolaminate can be used in an amount of 0.01 parts by mass or more and 5 parts by mass or less relative to 100 parts by mass of the total amount of the alcohol component and the carboxylic acid component; an esterification promoter such as gallic acid (same as 3,4,5-trihydroxybenzoic acid) can be used in an amount of 0.001 parts by mass or more and 0.5 parts by mass or less relative to 100 parts by mass of the total amount of the alcohol component and the carboxylic acid component; and further if desired, a radical polymerization inhibitor such as 4-tert-butylcatechol can be used in an amount of 0.001 parts by mass or more and 0.5 parts by mass or less relative to 100 parts by mass of the total amount of the alcohol component and the carboxylic acid component in polycondensation.

The polycondensation temperature is preferably 120° C. or higher, more preferably 160° C. or higher, even more preferably 180° C. or higher, and is preferably 250° C. or lower, more preferably 230° C. or lower.

Polycondensation can be carried out in an inert gas atmosphere.

From the viewpoint of further promoting polycondensation and optionally reaction with a bireactive monomer, a part of the carboxylic acid component may be first subjected to polycondensation and then, after addition polymerization followed by elevation of the reaction temperature, the remaining part of the component may be added to the reaction system as one preferred embodiment of the reaction mode.

In addition polymerization, a raw material monomer for a vinylic resin segment and a bireactive monomer are subjected to addition polymerization.

The addition polymerization temperature is preferably 110° C. or higher, more preferably 130° C. or higher, and is preferably 220° C. or lower, more preferably 200° C. or lower. Preferably, the pressure in the reaction system in the latter half of polymerization is reduced to promote the reaction.

As the polymerization initiator for addition polymerization, any known polymerization initiator can be used, and examples thereof include peroxides such as di-tert-butyl peroxide; persulfates such as sodium persulfate; and azo compounds such as 2,2′-azobis(2,4-dimethylvaleronitrile).

The amount of the polymerization initiator to be used is preferably 1 part by mass or more relative to 100 parts by mass of the raw material monomer for the vinylic resin segment, more preferably 3 parts by mass or more, even more preferably 5 parts by mass or more, and is preferably 20 parts by mass or less, more preferably 15 parts by mass or less, even more preferably 10 parts by mass or less.

The content of the composite resin (A) in the binder resin for the toner is, from the viewpoint of more improving toner gloss and carrier contamination resistance, preferably 0.5% by mass or more, more preferably 1% by mass or more, even more preferably 2% by mass or more, still more preferably 5% by mass or more, further more preferably 8% by mass or more, and is, from the viewpoint of more improving toner low-temperature fusing property, preferably 60% by mass or less, more preferably 50% by mass or less, even more preferably 40% by mass or less, still more preferably 30% by mass or less, and further more preferably 20% by mass or less.

The composite resin (A) can be used also as a wax dispersant in the toner particles. Namely, a wax can be finely dispersed in the amorphous polyester resin (B). Use of the composite resin (A) for wax dispersion can be carried out by incorporating the resin into toner particles containing a wax as a raw material.

### <Amorphous Polyester Resin (B)>

Examples of the polyester resin (B) include a polyester resin, and a modified polyester resin. Examples of the modified polyester resin include a urethane-modified polyester resin, an epoxy-modified polyester resin, and a composite resin containing a polyester resin segment and a vinylic resin segment. Among these, a polyester resin or a urethane-modified polyester resin is preferred, and a polyester resin is more preferred.

A polyester resin is, for example, a polycondensate of an alcohol component and a carboxylic acid component.

Examples of the alcohol component include an aromatic diol, a linear or branched aliphatic diol, an alicyclic diol, and a trihydric or higher polyalcohol.

Examples of the carboxylic acid component include a dicarboxylic acid, and a tribasic or higher polycarboxylic acid. Examples of the dicarboxylic acid include an aromatic dicarboxylic acid, a linear or branched aliphatic dicarboxylic acid, and an alicyclic dicarboxylic acid.

Preferred examples of the polyester resin (B) include:

a polyester resin (B-1) containing a polycondensate of an alcohol component containing an aromatic diol and a carboxylic acid component containing an aromatic dicarboxylic acid or a urethane-modified derivative thereof;

a polyester resin (B-2) which is a polycondensate of an alcohol component containing an aliphatic diol having a hydroxy group bonding to a secondary carbon atom and a carboxylic acid component; and

a polyester resin (B-3) which is a polycondensate of an alcohol component containing an aromatic diol and an aliphatic diol having 2 or more and 6 or less carbon atoms, and a carboxylic acid component.

### (Polyester Resin (B-1))

The alcohol component of the polyester resin (B-1) is preferably an aromatic diol.

The aromatic diol is preferably an alkylene oxide adduct of bisphenol A, and is more preferably an alkylene oxide adduct of bisphenol A represented by the above-mentioned formula (I).

The amount of the alkylene oxide adduct of bisphenol A is preferably 70 mol % or more in the alcohol component, more preferably 90 mol % or more, even more preferably 95 mol % or more, and is preferably 100 mol % or less, more preferably 100 mol %.

Examples of the alkylene oxide adduct of bisphenol A, the linear or branched aliphatic diol, the alicyclic diol and the trihydric or higher polyalcohol are the same as those exemplified hereinabove for the composite resin (A).

The carboxylic acid component of the polyester resin (B-1) is preferably an aromatic dicarboxylic acid.

The aromatic dicarboxylic acid is preferably isophthalic acid or terephthalic acid, and is more preferably terephthalic acid.

The amount of the aromatic dicarboxylic acid is preferably 20 mol % or more in the carboxylic acid component, more preferably 40 mol % or more, even more preferably 60 mol % or more, and is preferably 98 mol % or less, more preferably 95 mol % or less, even more preferably 90 mol % or less.

Preferably, the carboxylic acid component contains a tribasic or higher polycarboxylic acid, and preferably contains trimellitic acid or an anhydride thereof.

The amount of the tribasic or higher polycarboxylic acid is preferably 3 mol % or more in the carboxylic acid component, more preferably 5 mol % or more, even more preferably 10 mol % or more, and is preferably 40 mol % or less, more preferably 30 mol % or less, even more preferably 20 mol % or less.

Examples of the aromatic dicarboxylic acid, the linear or branched aliphatic dicarboxylic acid, and the tribasic or higher polycarboxylic acid are the same as those exemplified hereinabove for the composite resin (A).

The ratio of the carboxy group in the carboxylic acid component to the hydroxy group in the alcohol component is the same as that exemplified hereinabove for the composite resin (A).

Among the above, the polyester resin (B-1) preferably contains a polycondensate of an alcohol component containing an aromatic diol and a carboxylic acid component containing an aromatic dicarboxylic acid or a urethane-modified derivative thereof, and more preferably contains a polycondensate of an alcohol component containing an aromatic diol and a carboxylic acid component containing an aromatic dicarboxylic acid.

In the polyester resin (B), the content of the polycondensate of an alcohol component containing an aromatic diol and a carboxylic acid component containing an aromatic dicarboxylic acid or a urethane-modified derivative thereof is preferably 80% by mass or more, more preferably 90% by mass or more, even more preferably 95% by mass or more, and is preferably 100% by mass or less, more preferably 100% by mass.

### (Polyester Resin (B-2))

The alcohol component of the polyester resin (B-2) is preferably a linear or branched aliphatic diol, more preferably a branched aliphatic diol.

The branched aliphatic diol is preferably an aliphatic diol having a hydroxy group bonding to a secondary carbon atom.

The carbon number of the aliphatic diol having a hydroxy group bonding to a secondary carbon atom is preferably 3 or more and 6 or less.

Examples of the aliphatic diol having a hydroxy group bonding to a secondary carbon atom include propylene glycol, 1,2-butanediol, 1,3-butanediol, 2,3-butanediol, 1,2-pentanediol, 1,3-pentanediol, 1,4-pentanediol, 2,3-pentanediol, 2,4-pentanediol, 1,2-hexanediol, 1,5-hexanediol, 2,5-hexanediol, and 3,3-dimethyl-1,2-butanediol. Among these, propylene glycol is preferred.

The amount of the aliphatic diol having a hydroxy group bonding to a secondary carbon atom is preferably 20 mol % or more in the alcohol component, more preferably 40 mol % or more, even more preferably 60 mol % or more, still more preferably 70 mol % or more, further more preferably 75 mol % or more, and is preferably 100 mol % or less, more preferably 90 mol % or less, even more preferably 85 mol % or less, still more preferably 82 mol % or less.

Examples of other linear or branched aliphatic diols than the aliphatic diol having a hydroxy group bonding to a secondary carbon atom include ethylene glycol, 1,4-butanediol, and neopentyl glycol. Among these, ethylene glycol or 1,4-butanediol is preferred.

The amount of the other linear or branched aliphatic diol than the aliphatic diol having a hydroxy group bonding to a secondary carbon atom is preferably 10 mol % or more in the alcohol component, more preferably 15 mol % or more, even more preferably 18 mol % or more, and is preferably 60 mol % or less, more preferably 40 mol % or less, even more preferably 30 mol % or less, still more preferably 25 mol % or less, further more preferably 23 mol % or less.

Examples of the aromatic diol, the alicyclic diol and the trihydric or higher polyalcohol are same as those exemplified hereinabove for the composite resin (A).

The carboxylic acid component of the polyester resin (B-2) is preferably an aromatic dicarboxylic acid.

The aromatic dicarboxylic acid is preferably isophthalic acid or terephthalic acid, and more preferably terephthalic acid.

The amount of the aromatic dicarboxylic acid is preferably 40 mol % or more in the carboxylic acid component, more preferably 50 mol % or more, even more preferably 60 mol % or more, and is preferably 95 mol % or less, more preferably 90 mol % or less, even more preferably 85 mol % or less.

Examples of the linear or branched aliphatic dicarboxylic acid include oxalic acid, malonic acid, maleic acid, fumaric acid, citraconic acid, itaconic acid, glutaconic acid, succinic acid, adipic acid, and succinic acid substituted with an alkyl group having 1 or more and 20 or less carbon atoms or an alkenyl group having 2 or more and 20 or less carbon atoms. Among these, succinic acid is preferred.

Examples of the substituted succinic acid include dodecylsuccinic acid, dodecenylsuccinic acid and octenylsuccinic acid. Among these, dodecenylsuccinic anhydride is preferred.

The amount of the linear or branched aliphatic dicarboxylic acid is preferably 1 mol % or more in the carboxylic acid component, more preferably 3 mol % or more, even more preferably 5 mol % or more, and is preferably 50 mol % or less, more preferably 40 mol % or less, even more preferably 30 mol % or less.

Preferably, the carboxylic acid component contains a tribasic or higher polycarboxylic acid, and more preferably contains trimellitic acid or an anhydride thereof.

The amount of the tribasic or higher polycarboxylic acid is preferably 5 mol % or more in the carboxylic acid component, more preferably 8 mol % or more, even more preferably 10 mol % or more, and is preferably 40 mol % or less, more preferably 30 mol % or less, even more preferably 20 mol % or less.

Examples of the aromatic dicarboxylic acid, the linear or branched aliphatic dicarboxylic acid and the tribasic or higher polycarboxylic acid are the same as those exemplified hereinabove for the composite resin (A).

The ratio of the carboxy group in the carboxylic acid component to the hydroxy group in the alcohol component is the same as that exemplified hereinabove for the composite resin (A).

Among the above, the polyester resin (B-2) preferably contains a polycondensate of an alcohol component containing a linear or branched aliphatic diol and a carboxylic acid component containing an aromatic dicarboxylic acid, and more preferably contains a polycondensate of an alcohol component containing an aliphatic diol having a hydroxy group bonding to the secondary carbon atom and a carboxylic acid component containing an aromatic dicarboxylic acid.

In the polyester resin (B-2), the content of the polycondensate of an alcohol component containing a linear or branched aliphatic diol and a carboxylic acid component containing an aromatic dicarboxylic acid is preferably 80% by mass or more, more preferably 90% by mass or more, even more preferably 95% by mass or more, and is preferably 100% by mass or less, more preferably 100% by mass.

The alcohol component of the polyester resin (B-3) preferably contains an aromatic diol and an aliphatic diol having 2 or more and 6 or less carbon atoms.

The aromatic diol is preferably an alkylene oxide adduct of bisphenol A, and is more preferably an alkylene oxide adduct of bisphenol A represented by the above-mentioned formula (I).

The amount of the alkylene oxide adduct of bisphenol A is preferably 20 mol % or more in the alcohol component, more preferably 30 mol % or more, even more preferably 40 mol % or more, further more preferably 45 mol % or more, and is preferably 90 mol % or less, more preferably 70 mol % or less, even more preferably 60 mol % or less, and further more preferably 55 mol % or less.

Examples of the aliphatic diol having 2 or more and 6 or less carbon atoms include ethylene glycol, propylene glycol, 1,3-propanediol, 1,2-butanediol, 1,3-butanediol, 1,4-butanediol, 2,3-butanediol, neopentyl glycol, and 1,6-hexanediol. Among these, ethylene glycol, propylene glycol, 1,4-butanediol, and neopentyl glycol are preferred, and ethylene glycol is more preferred.

The amount of the aliphatic diol having 2 or more and 6 or less carbon atoms is preferably 10 mol % or more in the alcohol component, more preferably 30 mol % or more, even more preferably 40 mol % or more, further more preferably 45 mol % or more, and is preferably 80 mol % or less, more preferably 70 mol % or less, even more preferably 60 mol % or less, and further more preferably 55 mol % or less.

In the alcohol component of the polyester resin (B-3), the ratio by mol of the aliphatic diol having 2 or more and 6 or less carbon atoms to the aromatic diol is preferably 5/95 or more, more preferably 20/80 or more, even more preferably 30/70 or more, further more preferably 40/60 or more, still further more preferably 45/55 or more, and is preferably 90/10 or less, more preferably 80/20 or less, even more preferably 70/30 or less, further more preferably 60/40 or less, and still further more preferably 55/45 or less.

In addition to the aromatic diol and the aliphatic diol having 2 or more and 6 or less carbon atoms, the polyester resin may further contain, as the alcohol component, any other linear or branched aliphatic diol, an alicyclic diol and a trihydric or higher polyalcohol.

Examples of the other linear or branched aliphatic diol, the alicyclic diol and the trihydric or higher polyalcohol are the same as those exemplified hereinabove for the composite resin (A).

The carboxylic acid component of the polyester resin (B-3) is preferably an aromatic dicarboxylic acid.

The aromatic dicarboxylic acid is preferably isophthalic acid or terephthalic acid, and is more preferably terephthalic acid.

The amount of the aromatic dicarboxylic acid in the carboxylic acid component is preferably 40 mol % or more, more preferably 60 mol % or more, even more preferably 70 mol % or more, further more preferably 75 mol % or more, and is preferably 90 mol % or less, more preferably 85 mol % or less, even more preferably 80 mol % or less.

The linear or branched aliphatic dicarboxylic acid is preferably adipic acid.

The amount of the linear or branched aliphatic dicarboxylic acid in the carboxylic acid component is preferably 5 mol % or more, more preferably 8 mol % or more, even more preferably 10 mol % or more, and is preferably 30 mol % or less, more preferably 20 mol % or less, even more preferably 15 mol % or less.

The carboxylic acid component preferably contains a tribasic or higher polycarboxylic acid, and preferably contains trimellitic acid or an anhydride thereof.

The amount of the tribasic or higher polycarboxylic acid in the carboxylic acid component is preferably 3 mol % or more, more preferably 5 mol % or more, even more preferably 10 mol % or more, and is preferably 30 mol % or less, more preferably 20 mol % or less, even more preferably 15 mol % or less.

Examples of the aromatic dicarboxylic acid, the linear or branched aliphatic dicarboxylic acid, and the tribasic or higher polycarboxylic acid are the same as those exemplified hereinabove for the composite resin (A).

The ratio of the carboxy group in the carboxylic acid component to the hydroxy group in the alcohol component is the same as that exemplified hereinabove for the composite resin (A).

In the polyester resin (B-3), the content of the polycondensate of an alcohol component containing an aromatic diol and an aliphatic diol having 2 or more and 6 or less carbon atoms and a carboxylic acid component is preferably 80% by mass or more, more preferably 90% by mass or more, even more preferably 95% by mass or more, and is 100% by mass or less, preferably 100% by mass.

### [Physical Properties of Amorphous Polyester Resin (B)]

The acid value of the polyester resin (B) is preferably 3 mgKOH/g or more, more preferably 5 mgKOH/g or more, even more preferably 6 mgKOH/g or more, further more preferably 8 mgKOH/g or more, still further more preferably 10 mgKOH/g or more, still further more preferably 12 mgKOH/g or more, and is preferably 40 mgKOH/g or less, more preferably 30 mgKOH/g or less, even more preferably 20 mgKOH/g or less.

The hydroxyl value of the polyester resin (B) is preferably 5 mgKOH/g or more, more preferably 10 mgKOH/g or more, even more preferably 15 mgKOH/g or more, still more preferably 20 mgKOH/g or more, further more preferably 25 mgKOH/g or more, and is preferably 60 mgKOH/g or less, more preferably 50 mgKOH/g or less, even more preferably 45 mgKOH/g or less, further more preferably 40 mgKOH/g or less.

The softening point of the polyester resin (B) is, from the viewpoint of more improving low-temperature fusing property, preferably 70° C. or higher, more preferably 90° C. or higher, even more preferably 110° C. or higher, still more preferably 120° C. or higher, further more preferably 130° C. or higher, and is preferably 150° C. or lower, more preferably 145° C. or lower, even more preferably 140° C. or lower, still more preferably 135° C. or lower, further more preferably 130° C. or lower.

The glass transition temperature of the polyester resin (B) is, from the viewpoint of more improving the gloss and the carrier contamination resistance of toner, preferably 40° C. or higher, more preferably 45° C. or higher, even more preferably 50° C. or higher, further more preferably 55° C. or higher, still further more preferably 60° C. or hither, and is preferably 80° C. or lower, more preferably 75° C. or lower, even more preferably 70° C. or lower, still more preferably 65° C. or lower.

The acid value, the hydroxyl value, the softening point and the glass transition temperature of the polyester resin (B) can be appropriately controlled depending on the kind and the amount of the raw material monomers, and on the production conditions such as the reaction temperature, the reaction time and the cooling rate, and the values can be determined according to the methods described in the section of Examples.

In the case where two or more kinds of polyester resins (B) are used as combined, preferably, the acid value, the hydroxyl value, the softening point and the glass transition temperature of the resultant mixture each fall within the above-mentioned range.

The polyester resin (B) can be obtained, for example, through polycondensation of an alcohol component and a carboxylic acid component. Regarding the conditions for the polycondensation, for example, the conditions shown hereinabove for the polycondensation for the composite resin (A) may be referred to.

The ratio by mass of the composite resin (A) to the polyester resin (B) [(A)/(B)] is, from the viewpoint of providing a toner excellent in gloss and carrier contamination resistance, 1/99 or more, preferably 2/98 or more, more preferably 5/95 or more, even more preferably 8/92 or more, and is, from the viewpoint of providing a toner excellent in low-temperature fusing property and carrier contamination resistance, 60/40 or less, preferably 50/50 or less, more preferably 40/60 or less, even more preferably 30/70 or less, still more preferably 20/80 or less.

The content of the polyester resin (B) in the binder resin in the toner is, from the viewpoint of more improving the low-temperature fusing property, the gloss and the carrier contamination resistance of toner, preferably 40% by mass or more, more preferably 50% by mass or more, even more preferably 60% by mass or more, still more preferably 70% by mass or more, further more preferably 80% by mass or more, and is preferably 99.5% by mass or less, more preferably 99% by mass or less, even more preferably 98% by mass or less, still more preferably 95% by mass or less, further more preferably 92% by mass or less.

In the binder resin in the toner, the content of the composite resin (A) and the polyester resin (B) is preferably 80% by mass or more, more preferably 90% by mass or more, even more preferably 95% by mass or more, and is 100% by mass or less, preferably 100% by mass.

### <Crystalline Polyester Resin (C)>

The toner contains a crystalline polyester resin (C) from the viewpoint of providing a toner excellent in low-temperature fusing property, high-temperature offset resistance and durability.

Examples of the crystalline polyester resin (C) include a polycondensate of an alcohol component and a carboxylic acid component.

The alcohol component is preferably an α,ω-aliphatic diol.

The carbon number of the α,ω-aliphatic diol is preferably 2 or more, more preferably 4 or more, even more preferably 6 or more, and is preferably 16 or less, more preferably 14 or less, even more preferably 12 or less.

Examples of the α,ω-aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, and 1,14-tetradecanediol. Among these, ethylene glycol, 1,6-hexanediol, or 1,10-decanediol is preferred, and 1,6-hexanediol is more preferred.

The amount of the α,ω-aliphatic diol in the alcohol component is preferably 80 mol % or more, more preferably 85 mol % or more, even more preferably 90 mol % or more, further more preferably 95 mol % or more, and is 100 mol % or less, preferably 100 mol %.

The alcohol component may contain any other alcohol component different from an α,ω-aliphatic diol. Examples of the other alcohol component include an aliphatic diol except an α,ω-aliphatic diol, such as 1,2-propylene glycol and neopentyl glycol, an aromatic diol such as an alkylene oxide of bisphenol A, and a trihydric or higher polyalcohol such as glycerin, pentaerythritol, and trimethylolpropane. One alone or two or more of these alcohol components may be used either singly or as combined.

### (Carboxylic Acid Component)

Examples of the carboxylic acid component include an aliphatic dicarboxylic acid.

The carbon number of the aliphatic dicarboxylic acid is preferably 4 or more, more preferably 8 or more, even more preferably 10 or more, and is preferably 14 or less, more preferably 12 or less.

Examples of the aliphatic dicarboxylic acid include fumaric acid, sebacic acid, dodecanedioic acid, and tetradecanedioic acid. Among these, sebacic acid, dodecanedioic acid or tetradecanedioic acid is preferred, and sebacic acid is more preferred. One alone or two or more of these carboxylic acid components may be used either singly or as combined.

The amount of the aliphatic dicarboxylic acid in the carboxylic acid component is preferably 80 mol % or more, more preferably 85 mol % or more, even more preferably 90 mol % or more, further more preferably 95 mol % or more, and is 100 mol % or less, preferably 100 mol %.

The carboxylic acid component may contain any other carboxylic acid component different from an aliphatic dicarboxylic acid. Examples of the other carboxylic acid component include an aromatic dicarboxylic acid such as terephthalic acid, and isophthalic acid, and a trihydric or higher polycarboxylic acid. One alone or two or more of these carboxylic acid components may be used either singly or as combined.

The ratio of the carboxy group in the carboxylic acid component to the hydroxy group in the alcohol component (COOH group/OH group) is preferably 0.7 or more, more preferably 0.8 or more, and is preferably 1.3 or less, more preferably 1.2 or less.

### [Physical Properties of Crystalline Polyester Resin (C)]

The softening point of the crystalline polyester resin (C) is, from the viewpoint of more improving durability, preferably 60° C. or higher, more preferably 70° C. or higher, even more preferably 75° C. or higher, and is, from the viewpoint of more improving low-temperature fusing property, preferably 150° C. or lower, more preferably 120° C. or lower, even more preferably 100° C. or lower.

The melting point of the crystalline polyester resin (C) is, from the viewpoint of more improving durability, preferably 50° C. or higher, more preferably 60° C. or higher, even more preferably 70° C. or higher, and is, from the viewpoint of more improving low-temperature fusing property, preferably 100° C. or lower, more preferably 90° C. or lower.

The acid value of the crystalline polyester resin (C) is, from the viewpoint of more improving durability and low-temperature fusing property, preferably 5 mgKOH/g or more, more preferably 10 mgKOH/g or more, and is preferably 35 mgKOH/g or less, more preferably 25 mgKOH/g or less, even more preferably 20 mgKOH/g or less.

The hydroxyl value of the crystalline polyester resin (C) is, from the viewpoint of more improving durability and low-temperature fusing property, preferably 1 mgKOH/g or more, more preferably 2 mgKOH/g or more, even more preferably 3 mgKOH/g or more, and is preferably 35 mgKOH/g or less, more preferably 30 mgKOH/g or less, even more preferably 20 mgKOH/g or less.

The softening point, the melting point, the acid value and the hydroxyl value of the crystalline polyester resin (C) can be appropriately controlled depending on the kind and the ratio of the raw material monomers, and on the production conditions such as the reaction temperature, the reaction time and the cooling rate. The values can be determined according to the methods described in the section of Examples given hereinunder. In the case where two or more kinds of crystalline resins are used as combined, preferably, the values of the softening point, the melting point, the acid value and the hydroxyl value of the resultant mixture each can fall within the above-mentioned range.

The crystalline polyester resin (C) can be obtained, for example, through polycondensation of an alcohol component and a carboxylic acid component. For the polycondensation conditions, for example, the conditions shown hereinabove for the polycondensation for the composite resin (A) can be referred to.

The ratio by mass of the crystalline polyester resin (C) to the total of the composite resin (A) and the polyester resin (B) [(C)/((A)+(B))] is, from the viewpoint of more improving the low-temperature fusing property, the high-temperature offset resistance and the durability of toner, preferably 1/99 or more, more preferably 2/98 or more, even more preferably 5/95 or more, further more preferably 8/92 or more, and is preferably 50/50 or less, more preferably 40/60 or less, even more preferably 30/70 or less, still more preferably 20/80 or less, further more preferably 15/85 or less.

The ratio by mass of the crystalline polyester resin (C) to the composite resin (A) [(C)/(A)] is, from the viewpoint of more improving the low-temperature fusing property, the high-temperature offset resistance and the durability of toner, preferably 10/90 or more, more preferably 20/90 or more, even more preferably 25/75 or more, and is preferably 70/30 or less, more preferably 60/40 or less, even more preferably 55/45 or less.

In the binder resin in the toner, the content of the composite resin (A), the amorphous polyester resin (B) and the crystalline polyester resin (C) is preferably 80% by mass or more, more preferably 90% by mass or more, even more preferably 95% by mass or more, and is 100% by mass or less, preferably 100% by mass.

### <Wax>

Examples of the wax include hydrocarbon wax, ester wax, silicone wax, and fatty acid amide wax.

Examples of the hydrocarbon wax include mineral or petroleum hydrocarbon wax such as paraffin wax and Fischer-Tropsch wax; and synthetic hydrocarbon wax such as polyolefin wax, e.g., polyethylene wax, polypropylene wax and polybutene wax.

Examples of the ester wax include mineral or petroleum ester wax such as montan wax; vegetable ester wax such as carnauba wax, rice wax and candelilla wax; and animal ester wax such as bees wax.

Examples of the fatty acid amide wax include oleamide and stearamide. One or more of these may be used.

Among these, from the viewpoint of more improving the low-temperature fusing property, the gloss and the carrier contamination resistance of toner, fatty acid amide wax and ester wax are preferred, and ester wax is more preferred.

The melting point of the wax is preferably 60° C. or higher, more preferably 70° C. or higher, and is preferably 160° C. or lower, more preferably 150° C. or lower, even more preferably 140° C. or lower.

In the case where two or more waxes are used as combined, preferably, the melting point of each wax falls within the above-mentioned range.

The wax content is preferably 0.1 parts by mass or more relative to 100 parts by mass of the binder resin, more preferably 1 part by mass or more, even more preferably 2 parts by mass or more, and is preferably 20 parts by mass or less, more preferably 10 parts by mass or less, even more preferably 5 parts by mass or less.

### <Charge Controlling Agent>

The toner may contain a charge controlling agent.

As a charge controlling agent, the toner may contain any of a positive charge controlling agent and a negative charge controlling agent.

Examples of the positive charge controlling agent include a nigrosine dye, such as “Nigrosine Base EX”, “Oil Black BS”, “Oil Black SO”, “Bontron N-01”, “Bontron N-04”, “Bontron N-07”, “Bontron N-09”, and “Bontron N-11” (all manufactured by Orient Chemical Industries, Co., Ltd.); a triphenylmethane dye having a tertiary amine as a side chain, a quaternary ammonium salt compound, such as “Bontron P-51” (manufactured by Orient Chemical Industries, Co., Ltd.), cetyltrimethylammonium bromide, “Copy Charge PX VP435” (manufactured by Clariant AG); a polyamine resin, such as “AFP-B” (manufactured by Orient Chemical Industries, Co., Ltd.); an imidazole derivative, such as “PLZ-2001” and “PLZ-8001” (all manufactured by Shikoku Chemicals Corporation); and a styrene-acrylic resin, such as “FCA-701PT” (manufactured by Fujikura Kasei Co., Ltd.).

Examples of the negative charge controlling agent include a metal-containing azo dye, such as “Valifast Black 3804”, “Bontron S-31”, “Bontron S-32”, “Bontron S-34”, and “Bontron S-36” (all manufactured by Orient Chemical Industries, Co., Ltd.), and “Aizen Spilon Black TRH” and “T-77” (all manufactured by Hodogaya Chemical Co., Ltd.); a metal compound of a benzilic acid compound, such as “LR-147” and “LR-297” (all manufactured by Japan Carlit Co., Ltd.), a metal compound of a salicylic acid compound, such as “Bontron E-81”, “Bontron E-84”, “Bontron E-88”, and “Bontron E-304” (all manufactured by Orient Chemical Industries, Co., Ltd.), and “TN-105” (manufactured by Hodogaya Chemical Co., Ltd.); a copper phthalocyanine dye; a quaternary ammonium salt, such as “Copy Charge NX VP434” (manufactured by Clariant AG), a nitroimidazole derivative; and an organic metal compound.

Among the charge controlling agents, a negative charge controlling agent is preferred, and a metal compound of a benzilic acid compound is more preferred.

The content of the charge controlling agent is preferably 0.01 part by mass or more relative to 100 parts by mass of the binder resin, more preferably 0.2 part by mass or more, and is preferably 10 parts by mass or less, more preferably 5 parts by mass or less, even more preferably 3 parts by mass or less, further more preferably 2 parts by mass or less.

### <Colorant>

The toner may contain a colorant.

The colorant may be any of dyes, pigments, and the like that have been used as a colorant for toner, and examples thereof include carbon black, phthalocyanine blue, permanent brown FG, brilliant fast scarlet, pigment green B, rhodamine-B base, solvent red 49, solvent red 146, solvent blue 35, quinacridone, carmine 6B, and disazo yellow. The toner of the present invention may be any of a black toner and a color toner.

The content of the colorant is, from the viewpoint of improving the image density of the toner, preferably 1 part by mass or more relative to 100 parts by mass of the binder resin, more preferably 2 parts by mass or more, and is preferably 40 parts by mass or less, more preferably 20 parts by mass or less, further preferably 10 parts by mass or less.

The toner may contain any other additives such as a magnetic powder, a fluidity enhancer, a conductivity controlling agent, a reinforcing filler such as a fibrous substance, an antioxidant, an anti-aging agent, and a cleaning property enhancer.

### [Method for Producing Toner]

The toner may be any toner produced according to a known method such as a melt-kneading method, an emulsion phase inversion method, a polymerization method or am emulsion aggregation method, but from the viewpoint of productivity and colorant dispersibility, a pulverized toner according to a melt-kneading method is preferred.

In the case of a pulverized toner, for example, the method for producing the toner includes:

Step 1: a step of melt-kneading toner raw materials containing a composite resin (A), a polyester resin (B) and a wax, and

Step 2: a step of pulverizing and classifying the melt mixture obtained in the step 1 to give toner particles.

The ratio by mass of the composite resin (A) to the polyester resin (B) [(A)/(B)] is, from the viewpoint of obtaining a toner excellent in low-temperature fusing property, gloss and carrier contamination resistance, 1/99 or more and 60/40 or less.

In the step 1, the toner raw materials may contain any other additive such as a charge controlling agent and a colorant. Preferably, the toner raw materials are previously mixed with a mixing machine such as a Henschel mixer or a ball mill, and then fed into a kneading machine.

The melt-kneading temperature is preferably 80° C. or higher, more preferably 100° C. or higher, even more preferably 120° C. or higher, and is preferably 160° C. or lower, more preferably 150° C. or lower.

The melt-kneading in the step 1 may be performed with a known kneader, such as a closed kneader, a single screw or twin screw extruder, or an open roll kneader. From the viewpoint of melt-mixing crystals, a twin screw extruder capable of being set at a high temperature is preferred.

The melt mixture obtained in the step 1 is cooled to a pulverizable degree and then fed to the subsequent step 2.

The pulverizing in the step 2 may be performed in multiple stages. For example, the resin kneaded material obtained by curing the melt-kneaded material may be coarsely pulverized to a size of approximately 1 mm or more and 5 mm or less, and then finely pulverized to the target particle diameter.

The pulverizing machine used in the pulverizing step is not particularly limited, and examples of the pulverizing machine that may be preferably used for coarse pulverizing include a hummer mill, an atomizer, and Rotoplex. Examples of the pulverizing machine that may be preferably used for fine pulverizing include a fluidized bed jet mill, a collision plate jet mill, and a rotary mechanical mill. From the viewpoint of pulverizing efficiency, a fluidized bed jet mill and a collision plate jet mill are preferably used, and a collision plate jet mill is more preferably used.

Examples of the classifier used for classification include a rotor classifier, an airflow classifier, an inertial classifier, and a sieve classifier. The pulverized product that is removed in the classifying step due to insufficient pulverizing may be again supplied to the pulverizing step, and the pulverizing step and the classifying step may be repeated depending on necessity.

The volume median diameter (D₅₀) of the toner particles is, from the viewpoint of obtaining high-quality images, preferably 2 μm or more, more preferably 3 μm or more, further preferably 4 μm or more, and is preferably 10 μm or less, more preferably 8 μm or less, further preferably 6 μm or less.

Preferably, the toner is processed with a fluidizer added to the surface of the toner particles as an external additive.

Examples of the external additive include inorganic fine particles, such as hydrophobic silica, titanium oxide fine particles, alumina fine particles, cerium oxide fine particles, and carbon black, and polymer fine particles, such as polycarbonate, polymethyl methacrylate, and a silicone resin. Among these, hydrophobic silica is preferred.

In the case where the toner particles are subjected to a surface treatment with an external additive, the amount of the external additive added is preferably 1 part by mass or more relative to 100 parts by mass of the toner particles, more preferably 2 parts by mass or more, even more preferably 3 parts by mass or more, and is preferably 5 parts by mass or less, more preferably 4.5 parts by mass or less, further preferably 4 parts by mass or less.

The toner is used for developing latent images formed in electrophotography, electrostatic recording, electrostatic printing or the like. The toner may be used as a one-component developer, or the toner, which is mixed with a carrier, may be used as a two-component developer.

In relation to the aforementioned embodiments, the present invention further discloses a toner for developing electrostatic images and a method for producing the toner described hereinunder.

<1> A toner for developing electrostatic images, containing an amorphous composite resin (A), an amorphous polyester resin (B), and a wax, wherein:

the amorphous composite resin (A) contains a polyester resin segment which is a polycondensate of an alcohol component containing an aromatic diol, preferably an alkylene oxide adduct of bisphenol A, and a carboxylic acid component containing an aliphatic dicarboxylic acid whose main chain has 8 or more and 14 or less carbon atoms, preferably 10 or more and 14 or less carbon atoms, a vinylic resin segment of an addition polymer of a raw material monomer containing a styrenic compound, preferably an addition polymer of a raw material monomer containing a styrenic compound and a vinylic monomer having an aliphatic hydrocarbon group having 3 or more and 22 or less carbon atoms, and a constitutional unit derived from a bireactive monomer, the constitutional unit bonding to the polyester resin segment and the vinylic resin segment each via a covalent bond; and has a glass transition temperature not lower than 45° C., and

the ratio by mass of the amorphous composite resin (A) to the amorphous polyester resin (B) [(A)/(B)] is 1/99 or more and 60/40 or less.

<2> The toner for developing electrostatic images according to <1>, wherein the amount of the aliphatic dicarboxylic acid whose main chain has 8 or more and 14 or less carbon atoms based on the carboxylic acid component of the amorphous composite resin (A) is preferably 2 mol % or more, more preferably 3 mol % or more, even more preferably 10 mol % or more, further more preferably 15 mol % or more, and is preferably 40 mol % or less, more preferably 35 mol % or less, even more preferably 30 mol % or less, further more preferably 25 mol % or less.
<3> The toner for developing electrostatic images according to <1> or <2>, wherein the aliphatic dicarboxylic acid is preferably a linear aliphatic carboxylic acid.
<4> The toner for developing electrostatic images according to any of <1> to <3>, wherein the styrenic compound is preferably at least one selected from styrene, methylstyrene, α-methylstyrene, β-methylstyrene, tert-butylstyrene, chlorostyrene, chloromethylstyrene, methoxystyrene, styrenesulfonic acid and a salt thereof, more preferably styrene.
<5> The toner for developing electrostatic images according to any of <1> to <4>, wherein the aliphatic hydrocarbon group-having vinylic monomer is preferably an alkyl ester of a (meth)acrylic acid, preferably at least one selected from (iso)propyl (meth)acrylate, (iso)butyl (meth)acrylate, (iso)hexyl (meth)acrylate, cyclohexyl (meth)acrylate, (iso)octyl (meth)acrylate (hereinafter this may be referred to as 2-ethylhexyl (meth)acrylate), (iso)decyl (meth)acrylate, (iso) do decyl (meth)acrylate, (iso)palmityl (meth)acrylate, (iso)stearyl (meth)acrylate, and (iso)behenyl (meth)acrylate, preferably 2-ethylhexyl (meth)acrylate is preferred.
<6> The toner for developing electrostatic images according to any of <1> to <5>, wherein the bireactive monomer is preferably a vinylic monomer having at least one functional group selected from a hydroxy group, a carboxy group, an epoxy group, a primary amino group and a secondary amino group, in the molecule, more preferably a vinylic monomer having a hydroxy group or a carboxy group, even more preferably a vinylic monomer having a carboxy group, still more preferably at least one selected from acrylic acid, methacrylic acid, fumaric acid and maleic acid, further more preferably at least one selected from acrylic acid and methacrylic acid, and still further more preferably acrylic acid.
<7> The toner for developing electrostatic images according to any of <1> to <6>, wherein the acid value of the amorphous composite resin (A) is preferably 5 mgKOH/g or more, more preferably 8 mgKOH/g or more, even more preferably 10 mgKOH/g or more, and is preferably 40 mgKOH/g or less, more preferably 35 mgKOH/g or less, even more preferably 30 mgKOH/g or less, further more preferably 23 mgKOH/g or less, and still further more preferably 17 mgKOH/g or less.
<8> The toner for developing electrostatic images according to any of <1> to <7>, wherein the ratio by mass of the amorphous composite resin (A) to the amorphous polyester resin (B) [(A)/(B)] is preferably 2/98 or more, more preferably 5/95 or more, even more preferably 8/92 or more, and is preferably 50/50 or less, more preferably 40/60 or less, even more preferably 30/70 or less, and further more preferably 20/80 or less.
<9> The toner for developing electrostatic images according to any of <1> to <8>, wherein the amorphous polyester resin (B) is preferably at least one selected from a polyester resin, a urethane-modified polyester resin, an epoxy-modified polyester resin, and a composite resin containing a polyester resin segment and a vinylic resin segment, more preferably a polyester resin or a urethane-modified polyester resin, even more preferably a polyester resin.
<10> The toner for developing electrostatic images according to <9>, wherein the polyester resin in the amorphous polyester resin (B) is a polycondensate of an alcohol component and a carboxylic acid component.
<11> The toner for developing electrostatic images according to <10>, wherein the alcohol component is preferably at least one selected from an aromatic diol, a linear or branched aliphatic diol, an alicyclic diol, and a trihydric or higher polyalcohol, and more preferably contains an aromatic diol.
<12> The toner for developing electrostatic images according to <10> or <11>, wherein the dicarboxylic acid component is preferably at least one selected from an aromatic dicarboxylic acid, a linear or branched aliphatic dicarboxylic acid and an alicyclic dicarboxylic acid, and more preferably contains an aromatic dicarboxylic acid.
<13> The toner for developing electrostatic images according to any of <1> to <12>, wherein the amorphous polyester resin (B) is preferably a polycondensate of an alcohol component containing an aromatic diol and a carboxylic acid component containing an aromatic dicarboxylic acid or a urethane-modified derivative thereof, more preferably a polycondensate of an alcohol component containing an aromatic diol and a carboxylic acid component containing an aromatic dicarboxylic acid.
<14> The toner for developing electrostatic images according to any of <1> to <12>, wherein the amorphous polyester resin (B) is a polyester resin which is a polycondensate of an alcohol component containing an aliphatic diol having a hydroxy group bonding to a secondary carbon atom and a carboxylic acid component.
<15> The toner for developing electrostatic images according to any of <1> to <12>, wherein the amorphous polyester resin (B) is a polyester resin which is a polycondensate of an alcohol component containing an aromatic diol and an aliphatic diol having 2 or more and 6 or less carbon atoms and a carboxylic acid component.
<16> The toner for developing electrostatic images according to any of <1> to <15>, further containing a crystalline polyester resin (C).
<17> The toner for developing electrostatic images according to any of <1> to <16>, wherein the wax is at least one selected from a hydrocarbon wax, an ester wax, a silicone wax, and an aliphatic acid amide wax.
<18> A method for producing a toner for developing electrostatic images, including:

Step 1: a step of melt-kneading toner raw materials containing an amorphous composite resin (A), an amorphous polyester resin (B) and a wax, and

Step 2: a step of pulverizing and classifying the melt mixture obtained in the step 1 to give toner particles, wherein:

the amorphous composite resin (A) contains a polyester resin segment which is a polycondensate of an alcohol component containing an aromatic diol, and a carboxylic acid component containing an aliphatic dicarboxylic acid whose main chain has 8 or more and 14 or less carbon atoms, a vinylic resin segment of an addition polymer of a raw material monomer containing a styrenic compound, and a constitutional unit derived from a bireactive monomer, the constitutional unit bonding to the polyester resin segment and the vinylic resin segment each via a covalent bond, and has a glass transition temperature not lower than 45° C., and

the ratio by mass of the amorphous composite resin (A) to the amorphous polyester resin (B) [(A)/(B)] is 1/99 or more and 60/40 or less.

<19> A wax dispersant containing an amorphous composite resin (A), which contains a polyester resin segment which is a polycondensate of an alcohol component containing an aromatic diol and a carboxylic acid component containing an aliphatic dicarboxylic acid whose main chain has 8 or more and 14 or less carbon atoms, a vinylic resin segment of an addition polymer of a raw material monomer containing a styrenic compound, and a constitutional unit derived from a bireactive monomer, the constitutional unit bonding to the polyester resin segment and the vinylic resin segment each via a covalent bond; and has a glass transition temperature not lower than 45° C.
<20> Use of an amorphous composite resin (A) containing a polyester resin segment which is a polycondensate of an alcohol component containing an aromatic diol and a carboxylic acid component containing an aliphatic dicarboxylic acid whose main chain has 8 or more and 14 or less carbon atoms, a vinylic resin segment of an addition polymer of a raw material monomer containing a styrenic compound, and a constitutional unit derived from a bireactive monomer, the constitutional unit bonding to the polyester resin segment and the vinylic resin segment each via a covalent bond; and having a glass transition temperature not lower than 45° C., for wax dispersion.
<21> Use according to <17> for wax dispersion in an amorphous polyester resin (B).

### EXAMPLES

Hereinunder the present invention is described specifically by Examples, but the present invention is not whatsoever restricted by these Examples. The physical properties of resins and others were measured according to the methods mentioned below.

### [Measurement]

### [Acid Value and Hydroxyl Value of Resin]

Measured according to JIS K 0070:1992. However, only for the solvent for the measurement, the mixed solvent of ethanol and ether as prescribed in JIS K 0070:1992 is changed to a mixed solvent of acetone and toluene (acetone/toluene=1/1 (by volume)).

### [Softening Point, Endothermic Highest Peak Temperature, and Glass Transition Temperature of Resin]

### (1) Softening Point

Using a flow tester “CFT-500D” (available from Shimadzu Corporation), 1 g of a sample is extruded through a nozzle having a die pore diameter of 1 mm and a length of 1 mm while heating the sample at a temperature rise rate of 6° C./minute and applying a load of 1.96 MPa thereto by a plunger. The softening point is determined as the temperature at which a half amount of the sample is flowed out when plotting a downward movement of the plunger of the flow tester relative to the temperature.

### (2) Endothermic Highest Peak Temperature

Using a differential scanning calorimeter “Q-20” (available from TA Instruments Japan Inc.), a sample is cooled from room temperature (20° C.) to 0° C. at a temperature drop rate of 10° C./minute and then allowed to stand as such under the conditions for 1 minute, and then heated up to 180° C. at a temperature rise rate of 10° C./minute to measure an endothermic heat amount thereof. Among the endothermic peaks observed in the thus measured characteristic curve, the temperature of the peak located on the highest temperature side is defined as the endothermic highest peak temperature.

### (3) Glass Transition Temperature

Using a differential scanning calorimeter “Q-20” (available from TA Instruments Japan Inc.), a sample is weighed in an amount of 0.01 to 0.02 g in an aluminum pan, heated up to 200° C. and then cooled from the temperature to 0° C. at a temperature drop rate of 10° C./minute. Next, the sample is heated at a temperature rise rate of 10° C./minute to measure an endothermic peak thereof. The temperature at which an extension of the baseline below the endothermic highest temperature is intersected with a tangential line having a maximum inclination of the curve in the range of from a rise-up portion to an apex of the peak is read as the glass transition temperature of the sample.

### [Melting Point of Wax]

Using a differential scanning calorimeter “Q100” (available from TA Instruments Japan Inc.), a sample is weighed in an amount of 0.02 g in an aluminum pan, heated up to 200° C. and then cooled from 200° C. to 0° C. at a temperature drop rate of 10° C./minute. Next, the sample is heated at a temperature rise rate of 10° C./minute to measure a heat quantity, and an endothermic highest peak temperature is read as the melting point of the sample.

### [Volume Median Diameter (D₅₀) of Toner Particles]

The volume median diameter (D₅₀) of toner particles is measured by the following method.

Measuring Apparatus: “Coulter Multisizer (registered trademark) III” (available from Beckman Coulter Inc.)

Aperture Diameter: 50 μm

Analyzing Software: “Multisizer (registered trademark) III Ver. 3.51” (available from Beckman Coulter Inc.)

Electrolyte Solution: “Isotone (registered trademark) II” (available from Beckman Coulter Inc.)

Dispersion: 5% electrolyte dispersion in polyoxyethylene lauryl ether “EMULGEN (registered trademark) 109P” (available from Kao Corporation, HLB (hydrophile-lipophile balance)=13.6)

### Dispersing Conditions:

Ten milligrams of a sample of toner particles are added to 5 mL of the aforementioned dispersion, and dispersed therein using an ultrasonic disperser for 1 minute. Thereafter, 25 mL of the electrolyte solution is added to the resultant dispersion, and the obtained mixture is further dispersed using the ultrasonic disperser for 1 minute to prepare a sample dispersion.

### Measuring Conditions:

The thus prepared sample dispersion was added to 100 mL of the electrolyte solution and the concentration thereof was so controlled that 30,000 particles therein could be measured for the particle size thereof in 20 seconds, and then 30,000 particles were measured to thereby determine the volume median diameter (D₅₀) of the toner particles from the particle size distribution thereof.

### [Production of Resin]

### Production Examples A1 to A10 (Composite Resins A1 to A10)

Raw material monomers for polyester except for trimellitic anhydride, as shown in Table 1, were charged into a 10-L four-necked flask equipped with a thermometer, a stainless steel stirring bar, a falling type condenser having a dewatering tube, and a nitrogen inlet tube, and heated up to 160° C. in a mantle heater in a nitrogen atmosphere. A mixture of raw material monomers for a vinylic resin segment, a bireactive monomer and a polymerization initiator was dropwise added thereto to carry out polymerization. Subsequently, an esterification catalyst was added, and heated up to 210° C. taking 5 hours. Next, trimellitic anhydride was put into the system, heated up to 220° C., and reacted under 8.0 kPa until the reaction mixture could have a softening point reaching the point as in Table 1, thereby preparing composite resins A1 to A10.

TABLE 1

| | | | Production Example | | | | | | | | | |
|---|---|---|---|---|---|---|---|---|---|---|---|---|
| | | | Production | | Production | | Production | | Production | | Production | |
| | | | Example | | Example | | Example | | Example | | Example | |
| | | | A1 | | A2 | | A3 | | A4 | | A5 | |
| | | | Resin | | | | | | | | | |
| | | | A-1 | | A-2 | | A-3 | | A-4 | | A-5 | |
| Raw Material | | | molar | charged | molar | charged | molar | charged | molar | charged | molar | charged |
| Monomers (P) for | | | ratio | amount | ratio | amount | ratio | amount | ratio | amount | ratio | amount |
| Polyester Resin | | | *2 | (g) | *2 | (g) | *2 | (g) | *2 | (g) | *2 | (g) |
| Segment | Alcohol | BPA-PO *1 | 80 | 3033 | 80 | 3033 | 80 | 3033 | 80 | 2333 | 80 | 3733 |
| | Component | BPA-EO *1 | 20 | 704 | 20 | 704 | 20 | 704 | 20 | 542 | 20 | 867 |
| | Carboxylic | Terephthalic acid | 65 | 1169 | 65 | 1169 | 65 | 1169 | 65 | 899 | 65 | 1439 |
| | Acid | Adipic acid | | | | | | | | | | |
| | Component | Sebacic acid | 20 | 438 | | | | | | | | |
| | | Dodecanedioic | | | 20 | 498 | | | 20 | 383 | 20 | 613 |
| | | acid | | | | | | | | | | |
| | | Tetradecanedioic | | | | | 20 | 559 | | | | |
| | | acid | | | | | | | | | | |
| | | Dodecenylsuccinic | | | | | | | | | | |
| | | anhydride | | | | | | | | | | |
| | | Trimellitic | 2 | 42 | 2 | 42 | 2 | 42 | 2 | 32 | 2 | 51 |
| | | anhydride | | | | | | | | | | |
| Bireactive | Acrylic acid | | 10 | 78 | 10 | 78 | 10 | 78 | 12 | 72 | 6 | 58 |
| Monomer | | | | | | | | | | | | |
| Raw Material | | | mass | charged | mass | charged | mass | charged | mass | charged | mass | charged |
| Monomers (V) for | | | % *3 | amount | % *3 | amount | % *3 | amount | % *3 | amount | % *3 | amount |
| Vinylic Resin | | | | (g) | | (g) | | (g) | | (g) | | (g) |
| Segment | Styrene | | 80 | 2220 | 80 | 2245 | 80 | 2270 | 80 | 3216 | 80 | 1276 |
| | 2-Ethylhexyl acrylate | | 20 | 555 | 20 | 561 | 20 | 567 | 20 | 804 | 20 | 319 |
| Polymerization | | | part by | charged | part by | charged | part by | charged | part by | charged | part by | charged |
| Initiator | | | mass | amount | mass | amount | mass | amount | mass | amount | mass | amount |
| | | | *4 | (g) | *4 | (g) | *4 | (g) | *4 | (g) | *4 | (g) |
| | Di-tert-butyl peroxide | | 6 | 167 | 6 | 168 | 6 | 170 | 6 | 241 | 6 | 96 |
| Esterification | | | part by | charged | part by | charged | part by | charged | part by | charged | part by | charged |
| Catalyst | | | mass | amount | mass | amount | mass | amount | mass | amount | mass | amount |
| | | | *5 | (g) | *5 | (g) | *5 | (g) | *5 | (g) | *5 | (g) |
| | Tin(II) di(2-ethylhexanoate) | | 0.5 | 42 | 0.5 | 42 | 0.5 | 43 | 0.5 | 43 | 0.5 | 42 |
| Amount of Polyester Resin Segment (mass %) | | | 64 | | 64 | | 64 | | 49 | | 79 | |
| Amount of Bireactive Monomer-derived | | | 1 | | 1 | | 1 | | 1 | | 1 | |
| Constitutional Unit (mass %) | | | | | | | | | | | | |
| Amount of Vinylic Resin Segment (mass %) | | | 35 | | 35 | | 35 | | 50 | | 20 | |
| Physical | Acid value [mgKOH/g] | | 14.7 | | 14.2 | | 12.9 | | 14.9 | | 16.0 | |
| Properties | Hydroxyl value [mgKOH/g] | | 30.9 | | 32.7 | | 30.5 | | 28.7 | | 36.4 | |
| | Softening point [° C.] | | 122.3 | | 121.7 | | 122.4 | | 125.4 | | 118.5 | |
| | Endothermic highest peak | | 61.6 | | 60.8 | | 59.9 | | 58.3 | | 62.8 | |
| | temperature [° C.] | | | | | | | | | | | |
| | Softening point/endothermic | | 2.0 | | 2.0 | | 2.0 | | 2.2 | | 1.9 | |
| | highest peak temperature | | | | | | | | | | | |
| | Glass transition | | 55.1 | | 54.3 | | 53.4 | | 52.9 | | 56.9 | |
| | temperature [° C.] | | | | | | | | | | | |
| | | | Production Example | | | | | | | | | |
| | | | Production | | Production | | Production | | Production | | Production | |
| | | | Example | | Example | | Example | | Example | | Example | |
| | | | A6 | | A7 | | A8 | | A9 | | A10 | |
| | | | Resin | | | | | | | | | |
| | | | A-6 | | A-7 | | A-8 | | A-9 | | A-10 | |
| Raw Material | | | molar | charged | molar | charged | molar | charged | molar | charged | molar | charged |
| Monomers (P) for | | | ratio | amount | ratio | amount | ratio | amount | ratio | amount | ratio | amount |
| Polyester Resin | | | *2 | (g) | *2 | (g) | *2 | (g) | *2 | (g) | *2 | (g) |
| Segment | Alcohol | BPA-PO *1 | 80 | 3033 | 80 | 3033 | 80 | 3033 | 80 | 3033 | 80 | 3033 |
| | Component | BPA-EO *1 | 20 | 704 | 20 | 704 | 20 | 704 | 20 | 704 | 20 | 704 |
| | Carboxylic | Terephthalic acid | 60 | 1079 | 75 | 1349 | 65 | 1169 | 65 | 1169 | 45 | 809 |
| | Acid | Adipic acid | | | | | | | 20 | 316 | | |
| | Component | Sebacic acid | | | | | | | | | 40 | 875 |
| | | Dodecanedioic | 30 | 748 | 5 | 125 | | | | | | |
| | | acid | | | | | | | | | | |
| | | Tetradecanedioic | | | | | | | | | | |
| | | acid | | | | | | | | | | |
| | | Dodecenylsuccinic | | | | | 20 | 576 | | | | |
| | | anhydride | | | | | | | | | | |
| | | Trimellitic | 2 | 42 | 2 | 42 | 2 | 42 | 2 | 42 | 2 | 42 |
| | | anhydride | | | | | | | | | | |

| | | | | | | | | | | | |
|---|---|---|---|---|---|---|---|---|---|---|---|
| Bireactive | Acrylic acid | 10 | 78 | 10 | 78 | 10 | 78 | 10 | 78 | 10 | 78 |
| Monomer | | | | | | | | | | | |
| Raw Material | | mass | charged | mass | charged | mass | charged | mass | charged | mass | charged |
| Monomers (V) for | | % *3 | amount | % *3 | amount | % *3 | amount | % *3 | amount | % *3 | amount |
| Vinylic Resin | | | (g) | | (g) | | (g) | | (g) | | (g) |
| Segment | Styrene | 80 | 2310 | 80 | 2166 | 80 | 2277 | 80 | 2171 | 80 | 2252 |
| | 2-Ethylhexyl acrylate | 20 | 577 | 20 | 542 | 20 | 569 | 20 | 543 | 20 | 563 |
| Polymerization | | part by | charged | part by | charged | part by | charged | part by | charged | part by | charged |
| Initiator | | mass | amount | mass | amount | mass | amount | mass | amount | mass | amount |
| | | *4 | (g) | *4 | (g) | *4 | (g) | *4 | (g) | *4 | (g) |
| | Di-tert-butyl peroxide | 6 | 173 | 6 | 162 | 6 | 171 | 6 | 163 | 6 | 169 |
| Esterification | | part by | charged | part by | charged | part by | charged | part by | charged | part by | charged |
| Catalyst | | mass | amount | mass | amount | mass | amount | mass | amount | mass | amount |
| | | *5 | (g) | *5 | (g) | *5 | (g) | *5 | (g) | *5 | (g) |
| | Tin(II) di(2-ethylhexanoate) | 0.5 | 44 | 0.5 | 41 | 0.5 | 43 | 0.5 | 41 | 0.5 | 43 |

| Amount of Polyester Resin Segment (mass %) | | 64 | 64 | 64 | 64 | 64 |
|---|---|---|---|---|---|---|
| Amount of Bireactive Monomer-derived | | 1 | 1 | 1 | 1 | 1 |
| Constitutional Unit (mass %) | | | | | | |
| Amount of Vinylic Resin Segment (mass %) | | 35 | 35 | 35 | 35 | 35 |
| Physical | Acid value [mgKOH/g] | 16.4 | 14.9 | 15.5 | 14.7 | 14.9 |
| Properties | Hydroxyl value [mgKOH/g] | 31.9 | 31.9 | 32.4 | 33.9 | 39.5 |
| | Softening point [° C.] | 122.4 | 119.9 | 118.9 | 120.9 | 113.9 |
| | Endothermic highest peak | 57.8 | 65.2 | 64.8 | 60.9 | 49.8 |
| | temperature [° C.] | | | | | |
| | Softening point/endothermic | 2.1 | 1.8 | 1.8 | 2.0 | 2.3 |
| | highest peak temperature | | | | | |
| | Glass transition | 51.8 | 58.7 | 57.3 | 55.4 | 43.0 |
| | temperature [° C.] | | | | | |

*1 BPA-PO means a polyoxypropylene (2.2) adduct of bisphenol A. BPA-EO means a polyoxyethylene (2.2) adduct of bisphenol A.
*2 This means an amount (part by mol) of a monomer constituting each of the raw material monomers (P) and the bireactive monomer when the alcohol component in the raw material monomers (P) is taken as 100 parts by mol.
*3 This means a content (mass %) of each monomer constituting the raw material monomer (V) based on the total amount of the raw material monomer (V).
*4 This means an added amount (part by mass) of the polymerization initiator when the total amount of the raw material monomers (V) is taken as 100 parts by mass.
*5 This means an added amount (part by mass) of the esterification catalyst when the total amount of the raw material monomers (P) is taken as 100 parts by mass.

### Production Example B1 (Resin B-1)

Raw material monomers for polyester except for trimellitic anhydride, as shown in Table 2, were charged into a 10-L four-necked flask equipped with a thermometer, a stainless steel stirring bar, a falling type condenser having a dewatering tube, and a nitrogen inlet tube, and polycondensed at 230° C. for 7 hours in a mantle heater in a nitrogen atmosphere. Trimellitic anhydride was added thereto at 200° C., then heated up to 210° C. for polycondensation and reacted until the reaction mixture could have a softening point reaching the point shown in the following Table, thereby preparing a resin (resin B-1).

### Production Examples B2 to B3 (Resins B-2 to B-3)

Raw material monomers for a polyester resin segment except for trimellitic anhydride, as shown in Table 2, were charged into a 10-L four-necked flask equipped with a thermometer, a stainless steel stirring bar, a falling type condenser having a dewatering tube, and a nitrogen inlet tube, then heated up to 220° C. in a mantle heater in a nitrogen atmosphere, taking 5 hours, and polycondensed at 220° C. for 3 hours. Trimellitic anhydride was added thereto at 200° C., then heated up to 210° C. for polycondensation under 8.0 kPa and reacted until the reaction mixture could have a softening point reaching the point shown in the following Table, thereby preparing resins (resins B-2 to B-3).

TABLE 2

| | | | Production Example | | | | | |
|---|---|---|---|---|---|---|---|---|
| | | | Production | | Production | | Production | |
| | | | Example B1 | | Example B2 | | Example B3 | |
| | | | Resin | | | | | |
| | | | B-1 | | B-2 | | B-3 | |
| Raw Material | | | molar | charged | molar | charged | molar | charged |
| Monomers (P) | | | ratio | amount | ratio | amount | ratio | amount |
| for Polyester | | | *2 | (g) | *2 | (g) | *2 | (g) |
| Resin | Alcohol | BPA-PO *1 | 50 | 2917 | | | 30 | 1750 |
| Segment | Component | BPA-EO *1 | 50 | 2708 | | | 20 | 1083 |
| | | Ethylene glycol | | | | | 50 | 517 |
| | | Propylene glycol | | | 80 | 1013 | | |
| | | 1,4-Butanediol | | | 20 | 300 | | |
| | Carboxylic | Terephthalic acid | 75 | 2075 | 70 | 1937 | 70 | 1937 |
| | Acid | Adipic acid | | | | | 10 | 243 |
| | Component | Dodecenylsuccinic | 0 | 0 | 5 | 222 | | |
| | | anhydride | | | | | | |
| | | Trimellitic | 10 | 320 | 10 | 320 | 10 | 320 |
| | | Anhydride | | | | | | |
| Esterification | | | part | charged | part | charged | part | charged |
| Catalyst | | | by | amount | by | amount | by | amount |
| | | | mass | (g) | mass | (g) | mass | (g) |
| | | | *3 | | *3 | | *3 | |

| | | | | | | |
|---|---|---|---|---|---|---|
| Tin(II) di(2-ethylhexanoate) | 0.5 | 40 | 0.5 | 19 | 0.5 | 29 |

| | | | | |
|---|---|---|---|---|
| Physical | Acid value [mgKOH/g] | 12.5 | 8.5 | 15.8 |
| Properties | Hydroxyl value [mgKOH/g] | 35.5 | 42.5 | 35.2 |
| | Softening point [° C.] | 130.5 | 132.5 | 125.1 |
| | Endothermic highest peak | | | |
| | temperature [° C.] | 74.1 | 69.2 | 64.9 |
| | Crystallinity index | 1.76 | 1.91 | 1.93 |
| | Glass transition temperature | 66.4 | 62.1 | 58.2 |
| | [° C.] | | | |

*1 BPA-PO means a polyoxypropylene (2.2) adduct of bisphenol A. BPA-EO means a polyoxyethylene (2.2) adduct of bisphenol A.
*2 This means an amount (part by mol) of a monomer constituting each of the raw material monomers (P) when the alcohol component in the raw material monomers (P) is taken as 100 parts by mol.
*3 This means an added amount (part by mass) of the esterification catalyst when the total amount of the raw material monomers (P) is taken as 100 parts by mass.

### Production Example C1 (Resin C-1)

Raw material monomers (P) for polyester resin shown in Table 3 were charged into a 10-L four-necked flask equipped with a thermometer, a stainless steel stirring bar, a falling type condenser having a dewatering tube, and a nitrogen inlet tube, and heated up to 200° C. in a mantle heater in a nitrogen atmosphere taking 8 hours. Subsequently, the esterification catalyst was added and reacted under 8.0 kPa until the reaction mixture could have a softening point reaching the point shown in Table 3, thereby preparing a crystalline polyester resin C-1.

TABLE 3

| Production Example | | | C1 | |
|---|---|---|---|---|
| Resin | | | C-1 | |
| | | | molar | charged |
| | | | ratio *1 | amount (g) |
| Raw Material | Alcohol | 1,6-hexanediol | 100 | 2360 |
| Monomers (P) | Component | | | |
| for Polyester | Carboxylic | sebacic acid | 100 | 4040 |
| Resin | Acid | | | |
| | Component | | | |
| | | | part by | charged |
| | | | mass *2 | amount (g) |

| | | | |
|---|---|---|---|
| Esterification | Tin(II) di(2-ethylhexanoate) | 0.2 | 13 |
| Catalyst | | | |

| | | |
|---|---|---|
| Physical | Acid value [mgKOH/g] | 15.4 |
| Properties | Hydroxyl value [mgKOH/g] | 13.3 |
| | Melting point [° C.] | 68.5 |
| | Crystallinity index | 1.1 |
| | Softening point [° C.] | 77.5 |

*1 This means a molar ratio of a monomer constituting each of the raw material monomers (P) when the alcohol component in the raw material monomers (P) is taken as 100 mol.
*2 This means an added amount (part by mass) of the esterification catalyst when the total amount of the raw material monomers (P) is taken as 100 parts by mass.

### [Production of Toner]

### Examples 1 to 13, and Comparative Examples 1 to 5

A binder resin at a ratio shown in Table 4, and 5 parts by mass of a colorant “ECB-301” (manufactured by Dainichiseika Color & Chemicals Mfg. Co., Ltd.), 1 part by mass of a negative charge controlling agent “LR-147” (manufactured by Japan Carlit Co., Ltd.), and 2 parts by mass of a release agent were well stirred with a Henschel mixer, and then melt-kneaded with a co-rotation twin screw extruder having a total length of the kneading part of 1,560 mm, a screw diameter of 42 mm, and a barrel inner diameter of 43 mm. The rotation speed of the roll was 200 r/min, the heating temperature inside the roll was 90° C., the temperature of the kneaded mixture was 140° C., the supplying rate of the mixture was 10 kg/hr, and the average retention time thereof was approximately 18 seconds. The resultant kneaded mixture was cooled from 140° C. down to 50° C. taking 1.5 hours, then cold-rolled at 50° C. using a cooling roller, left at 45° C. for 4 hours, and jet-milled to give toner particles having a volume median particle diameter (D₅₀) of 5.5 μm.

To 100 parts by mass of the resultant toner particles, 1.5 parts by mass of “Aerosil R-972” (hydrophobic silica, manufactured by Nippon Aerosil Co., Ltd., number-average particle diameter: 16 nm) and 1.0 part by mass of “SI-Y” (hydrophobic silica, manufactured by Nippon Aerosil Co., Ltd., number-average particle diameter: 40 nm) as external additives were added and mixed with a Henschel mixer at 3,600 r/min for 5 minutes, so as to perform an external addition treatment to give a toner.

### [Evaluation]

### [Low-Temperature Fusing Property]

A toner was charged into an apparatus modified from a copier “AR-505” (manufactured by Sharp Corporation) in such a manner that the fusing unit thereof could operate for fusion outside the apparatus to give an unfused image.

Subsequently, using a fusing unit (fusing rate 390 mm/sec) modified to be able to receive a total fusing pressure of 40 kgf while the temperature thereof was successively raised from 100° C. up to 240° C. at intervals of 10° C., the unfused image was tested for fusing at each temperature. “Unicef Cellophane” (manufactured by Mitsubishi Pencil Co., Ltd., width: 18 mm, JIS Z1522) was stuck to the fused image, led to pass through fusing rollers set at 30° C., and then the tape was peeled off. Using a reflection densitometer “RD-915” (manufactured by Macbeth Corporation), the optical reflection density of the image before tape application and after tape peeling, and the temperature of the fusing roller at which the ratio of the two (after peeling/before application) exceeded 90% for the first time was referred to as a lowest fusing temperature, and based on this, the low-temperature fusing property of the toner was evaluated. The paper used in the fusing test was “CopyBond SF-70NA” (manufactured by Sharp Corporation, 75 g/m²). The results are shown in Table 4. A toner whose lowest fusing temperature is lower is more excellent in low-temperature fusing property.

### [Gloss]

A toner was charged into an apparatus modified from a copier “AR-505” (manufactured by Sharp Corporation) in such a manner that the fusing unit thereof could operate for fusion outside the apparatus to print a 4 cm×4 cm solid print of an unfused image on paper “CopyBond SF-70NA” (manufactured by Sharp Corporation, 75 g/m²). Using an apparatus modified from an oilless fusing system of an external fusing unit “DL-2300” (manufactured by Konica Minolta, Inc.), in which the rotation speed of the fusing rolls was set at 265 mm/sec and the fusing roll temperature in the fusing unit was set at 160° C., the image was fused to give a fused image. The gloss of the fused image was measured. For measuring the gloss, a gloss meter “PG-1” (by Nippon Denshoku Industries Co., Ltd.) was used, and the light source was set at 60° to evaluate the gloss of the image. The results are shown in Table 4. A toner having a higher gloss value is better. In the present invention, a toner having a gloss of 8 or more is judged to be good.

### [Carrier Contamination Resistance]

A developer prepared by mixing 3 parts by mass of a toner and 97 parts by mass of a silicone-coated ferrite carrier having an average particle size of 90 μm (manufactured by Kanto Denka Kogyo Co., Ltd., saturation magnetization: 70 Amt/kg) was charged into a copier “Preter 50” (manufactured by Ricoh Company, Ltd.), and using this, an image at a coverage rate of 5% was printed continuously for 1 hour. After the printing test, the toner mixture was taken out, and using a sieve having an opening of 32 μm, the toner part was removed by suction to separate the carrier part. The carbon amount of the resultant carrier was measured using a carbon analyzer “EMIA-110” (by Horiba, Ltd.) to determine a difference (% by mass) thereof from the carbon amount in the carrier previously measured before mixed in the toner. The results are shown in Table 4. A smaller carbon amount difference means that the amount of the toner adhering to the carrier is smaller, that is, the carrier contamination is reduced and the toner is better.

TABLE 4

| | | | | | | | | | Evaluation | | |
|---|---|---|---|---|---|---|---|---|---|---|---|
| | Binder Resin | | | | | | | | Low- | | |
| | Composite | | Polyester | | Crystalline | | | | Temper- | | |
| | Resin (A) | | Resin (B) | | Resin (C) | | Wax*1 | | ature | | Carrier |
| | | Amount | | Amount | | Amount | | Amount | Fusing | | Contam- |
| | Resin | [part by | Resin | [part by | Resin | [part by | Resin | [part by | Property | | ination |
| | Code | mass] | Code | mass] | Code | mass] | Code | mass] | [° C.] | Gloss | Resistance |
| Example 1 | A-1 | 10 | B-1 | 90 | — | — | W-1 | 2 | 130 | 16 | 0.04 |
| Example 2 | A-2 | 10 | B-1 | 90 | — | — | W-1 | 2 | 130 | 15 | 0.03 |
| Example 3 | A-3 | 10 | B-1 | 90 | — | — | W-1 | 2 | 125 | 16 | 0.04 |
| Example 4 | A-2 | 2 | B-1 | 98 | — | — | W-1 | 2 | 130 | 14 | 0.08 |
| Example 5 | A-2 | 50 | B-1 | 50 | — | — | W-1 | 2 | 140 | 13 | 0.02 |
| Example 6 | A-4 | 10 | B-1 | 90 | — | — | W-1 | 2 | 140 | 13 | 0.06 |
| Example 7 | A-5 | 10 | B-1 | 90 | — | — | W-1 | 2 | 135 | 11 | 0.09 |
| Example 8 | A-6 | 10 | B-1 | 90 | — | — | W-1 | 2 | 125 | 13 | 0.05 |
| Example 9 | A-7 | 10 | B-1 | 90 | — | — | W-1 | 2 | 140 | 14 | 0.11 |
| Example 10 | A-1 | 10 | B-1 | 90 | — | — | W-2 | 2 | 130 | 15 | 0.03 |
| Example 11 | A-1 | 10 | B-1 | 80 | C-1 | 10 | W-1 | 2 | 115 | 15 | 0.19 |
| Example 12 | A-1 | 10 | B-2 | 90 | — | — | W-1 | 2 | 130 | 11 | 0.16 |
| Example 13 | A-1 | 10 | B-3 | 90 | — | — | W-1 | 2 | 130 | 11 | 0.12 |
| Comparative | A-8 | 10 | B-1 | 90 | — | — | W-1 | 2 | 140 | 7 | 0.31 |
| Example 1 | | | | | | | | | | | |
| Comparative | A-9 | 10 | B-1 | 90 | — | — | W-1 | 2 | 140 | 6 | 0.36 |
| Example 2 | | | | | | | | | | | |
| Comparative | A-2 | 65 | B-1 | 35 | — | — | W-1 | 2 | 150 | 10 | 0.29 |
| Example 3 | | | | | | | | | | | |
| Comparative | — | — | B1 | 100 | — | — | W-1 | 2 | 130 | 6 | 0.41 |
| Example 4 | | | | | | | | | | | |
| Comparative | A-10 | 10 | B-1 | 90 | — | — | W-1 | 2 | 130 | 9 | 0.46 |
| Example 5 | | | | | | | | | | | |

*1W-1: carnauba wax “C1” (manufactured by S. Kato & Co., melting point: 80° C.) W-2: paraffin wax “HNP-9” (manufactured by Nippon Seiro Co., Ltd., melting point: 80° C.)

The above-mentioned Examples and Comparative Examples confirm that the present invention provides a toner excellent in low-temperature fusing property, gloss and carrier contamination resistance.

1: A toner for developing electrostatic images, comprising an amorphous composite resin (A), an amorphous polyester resin (B), and a wax, wherein:
the amorphous composite resin (A) comprises a polyester resin segment which is a polycondensate of an alcohol component comprising an aromatic diol and a carboxylic acid component comprising an aliphatic dicarboxylic acid whose main chain has 8 or more and 14 or less carbon atoms, a vinylic resin segment of an addition polymer of a raw material monomer comprising a styrenic compound, and a constitutional unit derived from a bireactive monomer, the constitutional unit bonding to the polyester resin segment and the vinylic resin segment each via a covalent bond; and has a glass transition temperature not lower than 45° C., and
the ratio by mass of the amorphous composite resin (A) to the amorphous polyester resin (B) [(A)/(B)] is 1/99 or more and 60/40 or less.

2: The toner for developing electrostatic images according to claim 1, wherein the amount of the aliphatic dicarboxylic acid whose main chain has 8 or more and 14 or less carbon atoms based on the carboxylic acid component of the amorphous composite resin (A) is 2 mol % or more and 30 mol % or less.

3: The toner for developing electrostatic images according to claim 1, wherein the acid value of the amorphous composite resin (A) is 17 mgKOH/g or less.

4: The toner for developing electrostatic images according to claim 1, wherein the amorphous polyester resin (B) comprises a polycondensate of an alcohol component comprising an aromatic diol and a carboxylic acid component comprising an aromatic dicarboxylic acid, or a urethane-modified derivative thereof.

5: The toner for developing electrostatic images according to claim 1, wherein the amorphous polyester resin (B) comprises a polyester resin which is a polycondensate of an alcohol component comprising an aliphatic diol having a hydroxy group bonding to a secondary carbon atom and a carboxylic acid component.

6: The toner for developing electrostatic images according to claim 1, wherein the amorphous polyester resin (B) comprises a polyester resin which is a polycondensate of an alcohol component comprising an aromatic diol and an aliphatic diol having 2 or more and 6 or less carbon atoms and a carboxylic acid component.

7: The toner for developing electrostatic images according to claim 1, wherein the ratio by mass of the amorphous composite resin (A) to the amorphous polyester resin (B) [(A)/(B)] is 2/98 or more and 20/80 or less.

8: The toner for developing electrostatic images according to claim 1, further comprising a crystalline polyester resin (C).

9: A wax dispersant comprising an amorphous composite resin (A), which comprises a polyester resin segment which is a polycondensate of an alcohol component comprising an aromatic diol and a carboxylic acid component comprising an aliphatic dicarboxylic acid whose main chain has 8 or more and 14 or less carbon atoms, a vinylic resin segment of an addition polymer of a raw material monomer comprising a styrenic compound, and a constitutional unit derived from a bireactive monomer, the constitutional unit bonding to the polyester resin segment and the vinylic resin segment each via a covalent bond; and has a glass transition temperature not lower than 45° C.
